(19) United States
(12) Patent Application Publication
(10) Pub. No.: US 2014/0244180 A1
(43) Pub. Date: Aug. 28, 2014

(54) SHAPE ANALYSIS AND MASS SPECTROMETRY OF INDIVIDUAL MOLECULES BY NANOMECHANICAL SYSTEMS

(71) Applicant: CALIFORNIA INSTITUTE OF TECHNOLOGY, Pasedena, CA (US)

(72) Inventors: Michael L. ROUKES, Pasadena, CA (US); John E. Sader, Victoria (AU); Scott I. Kelber, Pasadena, CA (US); Mehmet Selim Hanay, Pasadena, CA (US)

(21) Appl. No.: 14/040,294

(22) Filed: Sep. 27, 2013

Related U.S. Application Data
(60) Provisional application No. 61/857,635, filed on Jul. 23, 2013.
(60) Provisional application No. 61/768,266, filed on Feb. 22, 2013.

(51) Int. Cl. H01J 49/00

(52) U.S. Cl. CPC H01J 49/0036
USPC 702/19; 702/23

(57) ABSTRACT

The spatial distribution of mass within an individual analyte can be imaged—in real time and with molecular-scale resolution—when it adsorbs onto a nanomechanical resonator. Each single-molecule adsorption event induces discrete, time-correlated perturbations to the modal frequencies of the device. By continuous monitoring of multiple vibrational modes, the spatial moments of mass distribution can be deduced for individual analytes, one-by-one, as they adsorb. This new method was validated for inertial imaging using both experimental multimode frequency-shift data and finite-element simulations—to analyze the inertial mass, position-of-adsorption, and the shape of individual analytes. Unlike conventional imaging, the spatial resolution of nanomechanical inertial imaging is not limited by wavelength-dependent diffraction phenomena; instead frequency fluctuation processes determine the ultimate attainable resolution. Advanced NEMS devices can provide atomic-scale resolution.

### RELATED APPLICATIONS

This application claims priority to U.S. provisional application 61/768,266 filed Feb. 22, 2013 and to U.S. provisional application 61/857,635 filed Jul. 23, 2013, which are each incorporated by reference herein in their entireties for all purposes.

### FEDERAL FUNDING STATEMENT

This invention was made with government support under grant number 1DP1OD006924 awarded by the National Institutes of Health. The government has certain rights in the invention.

### BACKGROUND

Nanoelectromechanical Systems (NEMS) are electronically controllable, submicron-scale mechanical devices used in fundamental studies [1-7] as well as application-oriented efforts [8-11, References cited are provided hereinbelow, and no admission is made that any of these references are prior art]. The field has been under active development since the early-1990s [13, 14]. NEMS technology has recently begun to move from the domain of academic laboratories into the domain of microelectronic foundries, especially within the framework of Nanosystems Alliance [15]. It is now possible to create thousands of devices in a single process run and use these devices in sensor experiments [16].

One application of NEMS technology is sensing of extremely small masses. The operation of NEMS as mass spectrometers relies on the precise measurements of mechanical resonances. Each mechanical mode of a NEMS device has a specific resonance frequency determined by the effective stiffness and the effective mass of the particular mode. The resonance frequency is continuously monitored in experiments by a specialized electronic circuitry while sample molecules are introduced. Abrupt downward jumps in the resonance frequency are induced when an individual particle is adsorbed by the structure. The frequency change is proportional to the mass of the molecule to first order, since the molecule increases the modal mass.

Nanomechanical mass sensing took off during the last decade. Attogram mass resolution was first attained through NEMS in 2000 [17]. Subsequent experiments [18-20] demonstrated the potential of the technique in 2004. Unprecedented mass resolution at the zeptogram (10-21 g) level was attained by our group [21] in 2006. Working with carbon nanotube NEMS, atomic scale mass sensing has been demonstrated by [22], [23] and [24] in 2008. First mass spectrometry experiments detecting individual protein molecules were conducted in our group [10] in 2009. Recently, mass resolution at the yoctogram (10-24 g) level has been achieved using carbon nanotubes [25] indicating that atom-by-atom identification of a molecule is potentially possible with NEMS-MS. Demonstration of real-time nanomechanical mass spectrometry at the single-molecule level has been achieved in our group last year [11], in studies where individual protein molecules and nanoparticles were measured.

These advances clearly indicate that the field of nanomechanical mass spectrometry (NEMS-MS) is developing into a practical technology. NEMS-MS has distinct capabilities over conventional methods of mass spectrometry (MS). Conventional MS technologies suffer from progressively degraded mass resolution with increasing molecular weight. Molecules larger than 1 MegaDalton (1 MDa, approximately 10-18 g) are generally beyond the province of most conventional techniques. Important biological structures (protein complexes, ribosomes, DNA supercoils, large organelles, viruses, bacteria) have molecular weight beyond this mass range, and therefore cannot be easily characterized by traditional MS. On the other hand, NEMS-MS works efficiently throughout this range, as its mass resolution does not decrease as a function of analyte mass. NEMS-MS will enable fundamental studies into these biological structures. With the ability to be fabricated en masse in microelectronic foundries, NEMS-MS is a potentially a low cost, high throughput and compact detector technology. It is the only technology that can weigh neutral atoms and molecules. As the field advances, biological structures that lie between the conventional MS threshold (about 1 MDa) and the optical microscopy limit (about 1 GDa) will be routinely characterized by NEMS-MS.

Although nanomechanical mass spectrometry has a potential niche in characterizing large molecules and biological structures, NEMS-MS theoretical and experimental techniques developed so far are in need of improvement. They have not been tailored to deal with large particles that can extend to a sizeable fraction of the mechanical structure. In the recent single-molecule experiments[10, 11], each molecule is assumed to have zero spatial extent and the subsequent data analysis has been performed under this ‘point-particle’ assumption. As particles with tens to hundreds of nanometers in size are characterized, the ‘point-particle’ assumption ceases to be a good approximation. Furthermore, ‘point-particle’ assumption prevents one from obtaining important parameters about the analyte, such as how much it extends along the beam and whether it has a symmetric or asymmetric spatial distribution. This additional characterization can be used to extend the sensing paradigm with NEMS devices. For instance the density of the particle can be estimated by combining mass and spatial extent measurements; using density information, the chemical composition of the particle can be inferred. This way one can discriminate, for instance, between a virus and a gold nanoparticle even though they may have the same mass. These two considerations (obtaining accurate mass estimates for large particles and performing spatial characterization) motivate the critical need for developing new analysis and measurement methods for dealing with the finite size of sample particles.

### SUMMARY

Embodiments described herein include, for example, methods of using instruments and devices, methods of making instruments and devices, and instruments and devices themselves, as well as related systems and subsystems including software and hardware and computer readable media.

For example, one embodiment provides for a method comprising: disposing a NEMS mass spectrometer resonator and disposing a sample flux so that the resonator can adsorb sample from the sample flux while the resonator is being driven in multiple resonance modes, collecting resonance frequency data, and estimating the mass and the shape of the sample from the resonance frequency data.

Another embodiment provides for a method comprising: disposing a NEMS mass spectrometer resonator in the path of a sample flux so that the resonator can adsorb sample from the sample flux while the resonator is being driven in multiple resonance modes; collecting resonance frequency data, and estimating the mass and the shape of the sample from the resonance frequency data.

Another embodiment provides for a method comprising: disposing a NEMS mass spectrometer resonator and disposing a sample flux so that the resonator can adsorb sample from the sample flux while the resonator is being driven in multiple resonance modes, collecting resonance frequency data, and deducing all spatial moments of the mass distribution for each adsorbate including total mass and position.

In one embodiment, the shape is estimated with use of a skewness parameter. In another embodiment, in measuring the shape of the sample, the sample is not assumed to have a zero spatial extent. In another embodiment, the method is used for real-time, single-particle mass and shape analysis simultaneously. In another embodiment, the method is used for determining if the sample has a symmetric or asymmetric spatial distribution. In another embodiment, the method is used to measure at least two samples and the shape and/or density of the two samples are compared.

In one embodiment, the sample flux comprises neutral atoms or molecules. In another embodiment, the sample flux comprises particles. In another embodiment, the sample flux comprises particles having average diameter of at least 100 nm. In another embodiment, the sample flux comprises nanoparticles. In another embodiment, the sample flux comprises polymer nanoparticles. In another embodiment, the sample flux comprises biological structures. In another embodiment, the sample flux comprises at least one protein or at least one virus.

In one embodiment, the resonator is driven with transduction of at least three modes of the resonator. In one embodiment, the resonator is driven with transduction of at least four modes of the resonator. In another embodiment, the resonator is driven with transduction of three to twelve modes of the resonator. In another embodiment, the resonator is driven with transduction of four to twelve modes of the resonator.

In one embodiment, the resonator is a cantilever, a doubly-clamped beam, or a membrane. In one embodiment, the resonator is driven simultaneously in its modes. In another embodiment, the resonator is driven sequentially in its modes. In yet another embodiment, the resonator is driven simultaneously and sequentially in its modes.

In one embodiment, the estimation step includes estimation for mass, position, or shape, or combinations thereof, carried out by inertial imaging. In another embodiment, the estimation step is carried out with use of adaptive fitting. In another embodiment, the estimation step is carried out with finite element modeling.

In one embodiment, the sample includes soft analytes. In another embodiment, the sample includes rigid analytes. In another embodiment, the resonator comprises a compliant surface layer. In another embodiment, an instrument is provided which is adapted for carrying out the methods described herein. One embodiment also provides a computer-readable media for carryout out the estimation step as described herein.

In one embodiment, the mass is estimated as a total mass, m, according to:

$$m \approx - 2 {\sum }_{n = 1}^{M} {α}_{n} {M}_{n} δ {f}_{n}$$

wherein:
αₙ is a factor used to weigh the nth mode;
Mₙ is the effective mass for the nth mode of the resonator.
δfₙ is the frequency shift observed in the nth mode of the resonator.
In another embodiment, the shape is estimated with use of a probability density function for position denoted by:

$$ρ ( x ) = \frac{Δμ ( x )}{m}$$

wherein:
m is total mass;
Δμ(x) is the mass distribution of the adsorbate.

In another embodiment, the shape of the adsorbate is estimated with use of the equations:

$$\begin{matrix}- \frac{2}{m} {\sum }_{n = 1}^{M} {β}_{n} {M}_{n} δ {f}_{n} = {\int }_{0}^{L} ρ ( x ) {\underbrace{{\sum }_{n = 1}^{M} {β}_{n} {{φ}_{n} ( x )}^{2}}}_{\approx x} d x \\ \approx {\int }_{0}^{L} ρ ( x ) x d x \\ = 𝔼 [ x ]\end{matrix}$$

wherein, the first moment (E[x]) of the particle is solved for; and
wherein
Mₙ is the effective mode mass of the device,
m is the mass of particle as calculated, and
βₙ is a factor (similar to but different than αₙ) that is used to weight the nth mode; and
wherein higher order moments of the particle (e.g. E[x²], E[x³], E[x⁴] . . . ) are calculated in the same way, using different weight factors (the sets of {βₙ}). Those weight factors are calculated using the middle part of the above equation that is set approximately equal to the value, x, (the position coordinate of the axis of the beam mode). Setting that middle part instead to different values such as x2, x3, x4, etc., generate the sets of factors (the sets of {βₙ}) that are used to calculate the higher order moments of the particle.

In other embodiments, the method comprises use of method steps comprising:

The k^{th} moment of the adsorbate's mass density distribution is given as:

m^{(k)}=−2MΣₙ₌₁^{N}αₙ^{(k)}Δₙ

Where:

m^{(k)} is the k^{th} moment

αₙ^{(k)} are calculated coefficients for the k^{th} moment and the n^{th} mode of the device

M is the total device mass

Δₙ is the measured frequency shift for the n^{th} mode (N total modes are measured)

The coefficients, αₙ^{(k)}, are calculated using:

$${g}^{( k )} ( r ) = {\sum }_{n = 1}^{N} {α}_{n}^{( k )} {\vert {Φ}_{n} ( r ) \vert}^{2}$$

where Φₙ(r) are the mode shapes of the device over the generalized spatial coordinate, ‘r’.

By setting g^{(k)}(r) to different values (for each k), different sets of {αₙ^{(k)}}can be calculated and these are then used to calculate the different kth moments of the adsorbates mass distribution.

For example, the adsorbate mass is found using the zeroeth (k=0) moment. The position requires using the zeroeth (k=0) and first (k=1) moments. The size is obtained from the standard deviation using the zeroeth, first, and second (k=2) moments, and so forth. It is known from existing statistical theory how to use the moments to estimate various indicators of the adsorbate (size and shape). Moreover, there are known statistical methods (one of which is used in FIG. 11b) that can estimate the complete mass density distribution of the adsorbate using a finite number of moments. The more modes of the device that are measured increases the number of measured moments which in turn increases the accuracy of the estimation of the adsorbate ‘actual’ mass density distribution.

At least one advantage for at least one embodiment is that one can measure the density of the sample and better distinguish the sample from other types of structures, including distinguishing two structures which are different but have the same mass. At least one additional advantage for at least one embodiment is the ability to detect large molecules and structures, including large biomolecules and biological structures. At least one additional advantage for at least one embodiment is the ability to detect large particles that can extend to a sizeable fraction of the mechanical structure. At least one additional advantage for at least one embodiment is excellent characterization of the degree of inaccuracy. At least one additional advantage for at least one embodiment is not being limited by wavelength-dependent diffraction phenomena (rather, frequency fluctuations determine the ultimate attainable resolution). Also, destructive ionization of samples can be avoided, and many (millions) of the resonators can be built onto a single chip.

Additional advantages for at least some embodiments include the ability to measure how the size of particles changes due to different growing or environmental affects; and/or the ability to image size and shape of particles to determine degrees of mass inhomogeneity-such features are often important in analyzing how the particle interacts (for example, proteins can bind at specific sites, and this technique can provide information about this binding strength and behavior).

### BRIEF DESCRIPTION OF THE DRAWINGS

FIG. 1: Linear Superposition of Modes: (a) The results of linear position of squared mode shapes are shown for different number of mode numbers. From inside to outside, depicted are the linear combination results of: 2 modes (green), 4 modes (magenta), 6 modes (blue), 8 modes (red) and 10 modes (black). (b) The residual between the fitting and the unity function are shown within the region of validity. From thicker to thinner curves: 10 mode (black), 8 mode (red) and 6 mode (blue) superpositions. (c) The effective area of the NEMS is shown as a function of mode shapes. With only 4 modes, the most sensitive 50% area is covered.

FIG. 2: The approximations for the moments of position. The functions to be approximated are shown in black dotted line in each case and they are, y=x in (a), y=X² in (b), and y=x³ in (c). In each case two linear combinations approximate the target functions well within the range of validity. Blue: 6, Red: 10 modes.

FIG. 3: Multimode NEMS. (a) NEMS device fabricated for the measurement of multiple resonances. The metallic loops (inset) on either edge of the structure are used for the drive and detection of the mechanical motion. The scale bar is 5 micrometers. (b) Measurement results from the mechanical structure in this case shows the first nine mechanical resonances. Higher frequency modes (inset) can be transduced to larger levels by applying more power at these frequencies. Both figures are adapted from [12].

FIG. 4: The Electronic Circuitry for Simultaneous Detection, shown here for 8 modes. On the drive branch, each function generator has a frequency (ωₙ/2) and on the bias branch corresponding function generator has the frequency ωₙ+_{Δ}ωₙ where ωₙ is the frequency of the nth mode and ωₙ is the mixed down frequency, which is set to a unique value for each mode to enable addressing. On the detection branch, a bypass capacitor provides ground for the high-frequency bias components; whereas low-frequency mixing components at ωₙ are amplified all-together by the low-noise amplifier and a buffer amplifier. Signal is then fanned out to on-board lock-in amplifiers for mode-specific amplification and detection. All the instruments can be implemented as on-board microchips, not standalone instruments.

FIG. 5: Rapid Sequential Detection of 20 Modes. Using the dedicated FPGA measurement platform with custom electronic boards, one can transduce multiple modes sequentially with switching and measurement rates down to 100 microseconds per NEMS. Here measurement of 20 resonances (each one of the first mode of a different NEMS device) within 500 milliseconds is shown.

FIG. 6: Nanoparticle Samples. Particles with different composition and size can be measured for the verification of the technique. Here PS: polystyrene, PMMA: Poly-methyl methacrylate and HLW: hollow polystyrene nanoparticle. In all cases error bars for mass and size are shown.

FIG. 7: Structure of Lambda Phage. The head is an icosahedron with 55 nm length. The tail is cylinder in shape with 175 nm total length and 12 nm diameter.

FIG. 8: Superpositions of fundamental mode shapes. (A) Mode shapes of a doubly-clamped beam for the first (black), second (blue), fourth (red), and tenth (green) out-of-plane flexural modes. (B) A linear combination of mode shapes intended to yield a superposition g⁽⁰⁾(x)=1 over an interval Ω spanning the entire beam [0, 1], using the first mode (black), first two modes (blue), first four modes (red) and first 10 modes (green). Significant over- and undershoot is evident. (C) Superpositions with slightly foreshortened interval provides greatly improved convergence; here Ω spans [δ, 1−δ] where δ=N/(1+N²); for an expansion involving the tenth mode (green) the interval [0.099, 0.901] covers about 80% of the beam.

FIG. 9: Adaptive fitting for enhanced resolution and accuracy. Shown is the superposition fit to g⁽⁰⁾(x)=1 (to calculate mass) for the same set of modes as in FIG. 8 for an exponentially shrinking measurement zone. (A) The initial superposition (solid black curve) before a particle arrives. After a particle arrives at x/L=0.35 (dotted black line), it is now possible to fit to a smaller measurement zone (solid blue curve) 10× smaller than the original, centered on the particle position. (B) After iteration, the new superposition (solid blue curve, inset in (A)) for the 10× zoom measurement zone centered on the particle position (dotted black line).

Further shrinking of the measurement zone by an additional factor of 10 (100× from the original) to a new measurement zone (solid green curve) is possible. (C) Final superposition function (solid green curve, inset in (B)) after 100× zoom on the measurement zone centered on the particle position. Error is reduced by six orders of magnitude from (A).

FIG. 10: Inertial imaging using experimental data. (A,B) Mass and position calculations, respectively for the experimental data from [7] using two modes of a doubly clamped beam. The values for mass and position are compared with the previous values from [7] using multimode theory. The error bars in inertial imaging theory reflect the total error due to both the fitting residual and frequency fluctuations. (C) Analysis of the particle mass for different positions using the four-mode measurement of the same particle along a cantilever device [17]. The particle expected mass is estimated from the SEM measurements of the paper [17](solid red line) with 2% assumed uncertainties in that measurement (dotted red lines). (D) Position calculation using the same data compared with the optically measured position. The red lines in (A), (B), and (D) represents curves of exact agreement between the two methods. Insets are electron micrograph of representative devices used in the two respective studies. In all figures the error bars represent the two-sigma, 95% confidence level.

FIG. 11: FEM Simulations. (A) A rectangular test particle (gray) is place at a random position along a doubly-clamped beam. The fourth out-of-plane displacement mode of the beam is shown. Colors represent displacement magnitude. (B) The simulated density profile of the test particle in the x-direction (black) revealing a step-wise distribution. The spatial moments derived using inertial imaging are used with Pearson's method to create an estimation of the simulated particle distribution (red curve). The frequency shifts in the first five out-of-plane displacement beam modes were used. (C) The simulated and calculated values of the first five spatial moments of the particle using the same frequency shifts utilized in (B).

FIG. 12: Ten-mode superposition functions to calculate the first, second and third moments. Bottom row: Red curves are the superposition function as a linear combination of the mode shapes. These are created using the coefficients to calculate the 1^{st}, a, 2^{nd}, b, and 3^{rd}, c, moments of the mass distribution of the particle. Red shading indicates the measurement zone used for these calculations ([N/(1+N²),½]). The solid black curves represent the fitting functions. It is clearly seen that the superpositions well match the fitting function within the measurement zone, but depart in the region (unshaded) outside the measurement zone. Top row: the residual of the superposition curves as approximations to the fitting function.

FIG. 13: Dependence of the measurement zone on the number of modes employed. (A) One to ten modes are superimposed to yield the function g⁽⁰⁾(x)=1. Black dots indicate the relative value of the measured mass of a particle at a given position, for inertial imaging calculations for mass using different numbers of modes. The red dots show the values for a particle landing outside the ten-mode measurement zone. (B) The extent of the measurement zone for calculations involving different numbers of modes (from one to ten). Note that the measurement zone for calculations involving one mode is the single point, X=0.5.

FIG. 14: Simulated adaptive fitting results for a highly skewed particle. A discrete particle with skew is placed at a specific position along the beam. (A) The particle's mass density distribution. Vertical (horizontal) dotted red line indicates the mean (twice the standard deviation). (B)-(E) The fractional errors of the moments of the mass distribution function for the particle, calculated by inertial imaging theory, for the mass (0ₜₕ moment), center-of-mass position (mean, 1ₛₜ), particle size, i.e., standard deviation (SD.; 2_{nd}), and particle asymmetry, i.e., skewness (3_{rd}), respectively. Colors indicate the highest number of modes used with [black, red, blue, cyan, magenta, yellow, navy] representing [2, 3, 4, 5, 6, 8, 10] modes, respectively.

FIG. 15: Variance of gold bead density distribution as a function of position. The measured variance (black squares) of the gold bead is shown for different particle positions. The error bars represent the 95% confidence level. The dotted red line marks the zero point, for reference.

FIG. 16: 3D FEM simulation of inertial imaging. A 400×100×10 nm (Lwt) particle is firmly attached to a 10,000×300×100 nm (Lwt) doubly-clamped Si nanomechanical resonator. Densities for the particle and beam are 5.00 and 2.33 g/cm³, respectively. The particle has a Young's Modulus of 10 MPa. These values give a ratio of the particle-to-beam mass of 2.861×10⁻³. The first four beam modes are used to calculate the adsorption-induced frequency shifts for these modes—this is performed for several positions shown in the table. An Allan deviation of about 5×10⁵ is assumed for all modes used in the simulation. As displayed in the table, the inertially-imaged values for particle mass, position, and size are in excellent agreement (less than a few percent) with actual particle properties.

FIG. 17: Convergence of FEM simulations for estimation of particle size. (A) The calculated mass averaged over 8 different beam positions as a function of number of mesh elements used in the FEM simulation. (B) The error in the position calculation averaged over all 8 positions as fractional percent of the simulated center-of-mass of the particle. (C) Same as in (A), but now for the variance of the particle distribution. In all plots, the error bars (rendered at 2-sigma level) are calculated by the statistics of size estimates at 8 different places along the beam. The red line shows the expected value of the measured quantity for the simulated particle.

### DETAILED DESCRIPTION

### Part 1: Generic to First and Second Priority Provisionals

The references cited in the Background Section and in the Cited References listing below can be referred to for providing enabling support herein.

Priority U.S. provisional application 61/768,266 filed Feb. 22, 2013 and priority U.S. provisional application 61/857,635 filed Jul. 23, 2013 are each incorporated by reference herein in their entireties including figures and mathematical formulae.

NEMS mass spectrometers and resonators are known in the art. Methods of making and methods of using these NEMS mass spectrometers and resonators are also known. See, for example, Reference 10 cited below to Naik et al. See also, for example, US Pat. Pub. 2012/0272742 and U.S. Pat. Nos. 7,302,856; 8,227,747; 7,989,198; 7,617,736; 7,552,645; 8,044,556; 8,350,578; 7,724,103; 7,555,938; 7,330,795; 6,722,200; and 8,329,452. See also U.S. application Ser. No. 13/890,087 filed May 8, 2013 to Roukes et al. See also US Pat. Pub. 2013/0238252 and Reference 18 cited below to Dohn et al.

As known in the art, a system or instrument can be used in which a sample is subjected to, for example, electrospray ionization (ESI) and sample molecules are guided to the resonator in vacuum with ion optics for adsorption onto the resonator. The sample flux is disposed in relation to the NEMS mass spectrometer resonator so that the resonator can adsorb sample from the sample flux, as known in the art.

As known in the art, electronic circuitry and control and measurement devices are provided to drive the resonator and to measure the mechanical response in frequency of resonator. Resonance frequency data can be collected. As known in the art, the resonator can be driven in multiple resonance modes.

Signal processing devices can be used to measure and estimate properties and characteristics of the samples.

### Part 2: First Priority Provisional

### Fabrication of NEMS Devices:

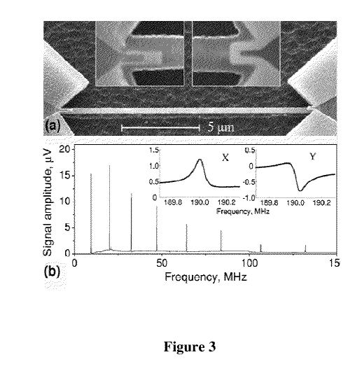

NEMS mass spectrometer resonators are known in the art. The resonator can be driven in multiple resonance modes. Transduction of many, ideally up to ten, modes can be carried out. Previously, one has been able to transduce a NEMS device up to its 12th mode [12]. In preferred embodiments for this work, the fundamental frequency was around 10 MHz and the 12th mode reached up to about 250 MHz. With detection capability in the GHz regime [26] one can transduce even smaller devices. A NEMS device which can be used is shown in FIG. 3. This device, in one embodiment, contains the structural material, silicon nitride, as well as two electrodes, such as metal or gold electrodes, for the excitation and detection of the mechanical motion. The excitation can be accomplished through the thermoelastic extraction-contraction cycles generated at the electrode through Joule heating. The mechanical motion can be detected from the other electrode on the beam through piezoresistive modulation [8]. For mass spectrometry experiments, one can fabricate similar NEMS devices, exciting at least two modes simultaneously and measuring particles such as gold nanoparticles with them [11]. One can fabricate similar devices for the transduction of many modes.

As examples of resonators, cantilevers and doubly-clamped beams can be fabricated. The theory presented herein considers a beam, but can be readily extended to the cantilever case (as well as additional structures such as membranes). Fabricating both beam and cantilever NEMS devices (amongst other structures) is known. The fabrication procedures for these devices are already described in the literature [12]. Minor modifications of the cited work can be carried out. Two e-beam lithography steps and one plasma etching step can be carried out. One can start with, for example, 100 nm thick low stress silicon nitride layers on silicon. One can first fabricate alignment marks as well as gold electrode(s) at the edge(s) defining the NEMS resonators by e-beam lithography and thermal evaporation of chromium followed by gold. Later, one can deposit SrF₂ as an etch mask, again using e-beam lithography and thermal evaporation. One can suspend the devices using anisotropic and isotropic plasma etching. One can remove the SrF₂ etch mask by dipping the chip into HCl for, for example, fifteen seconds. The resulting structure will be a fully suspended silicon nitride cantilever/doubly-clamped beam with gold electrode(s). FIG. 3 shows the SEM image of a similar device fabricated before.

One can use two different device dimensions including large and small device designs. The large device design (e.g., 10 microns length, 800 nm width, 100 nm thickness) can be used to carry out the methods with commercially available nanoparticles used as size standards (e.g., 100-400 nm). With the smaller device design (e.g, 4 micron length, 320 nm width, 100 nm thickness) one can weigh and size biological particles (e.g., viruses, supercoiled DNA and ribosomes). One can iterate on the dimensions and the fabrication parameters.

NEMS Measurements with Multiple Modes

One can transduce many mechanical modes of the same NEMS device with a suitable electronic system. In practice, four modes can be sufficient to obtain acceptable results with the present approach; however, one can pursue assembling a setup that is capable of tracking, for example, ten modes of the device.

One can use two different approaches in measuring multiple resonances. In one approach, a NEMS resonator is driven simultaneously at all of its (e.g., ten) modes. This feat can be achieved by combining the electronic signals for each mode through constructing the appropriate electronic circuitry—which is described in more detail below. The second approach is to sequentially measure each mode very rapidly. In this case, one can switch through each mode so quickly that only one molecule lands on the device within one measurement cycle. Dedicated hardware/software measurement platform that can measure any given mode and switch to a different mode all within 100 microseconds are known. Using this platform, for use often modes, all ten modes can be measured in a total of 1 ms, comfortably faster than the expected sample flux rate (about one per second) on the device. Below is described implementation methods for each strategy.

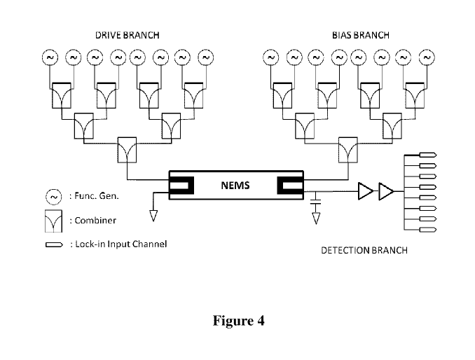

In the simultaneous transduction strategy, the electronic signals driving and detecting the resonator are superposed on the electrodes of the NEMS (FIG. 4). When multiple drive signals are superposed, the drive electrode on the NEMS can heat up in response to each signal:

$$W - \frac{{V}^{2}}{R} - \frac{{( {\sum }_{n = 1}^{M} {V}_{n} cos ( {ω}_{κ} t / 2 ) )}^{2}}{R}$$

Each resonance mode will be excited through its own signal at the squared frequency. There will be cross terms—however since no mechanical frequency falls on these cross terms, their only effect will be to slightly increase the temperature of the beam. The trade-offs in combining different drive signals on the beam are an increase in the average device temperature and a slight decrease in the onset-of-linearity for each mode; however, experience with simultaneous two-mode drive [11] suggests that neither of these factors depreciate the performance of NEMS resonators considerably in practice.

On the readout side, the piezoresistance change on the readout electrode will also vary in response to the mechanical motion of superposed modes. To readout each mode, one can use piezoresistive downmixing with different downmixing frequencies. In piezoresistive downmixing [27], the dynamic resistance of an electrode, (ω), oscillating at an RF frequency Ω can be efficiently detected by applying an RF current, I(ω+Δω), that is slightly detuned from the oscillation frequency by an adjustable amount (Δω) usually in the tens of kilohertz range. The resulting electrical voltage can carry a low-frequency component V(Δω) which can be detected efficiently with a lock-in amplifier (and which is immune to parasitic attenuation). By picking a different downmixing frequency, Δωₙ, for each mode one can in effect address each mode and track its motion independently by using a lock-in amplifier.

The instrumentation for the simultaneous detection of, for example, 10 modes nominally can comprise, for example, 10 lock-in amplifiers and 20 function generators. This would be costly and impractical to implement with stand-alone instruments. However, one can use a custom, field-programmable gate array (FPGA)-based electronic system that implements a complete NEMS measurement system (including function generators, lock-in amplifiers and low-noise amplifiers) on a single electronic board. At least several such custom systems are known, each one carrying, for example, six fully functional electronic measurement systems—these have been successfully employed in experiments in the past. Therefore, these systems can provide the infrastructure for the simultaneous excitation of, for example, 12 modes. RF power combiners and buffer amplifiers can be used to connect these systems (FIG. 4).

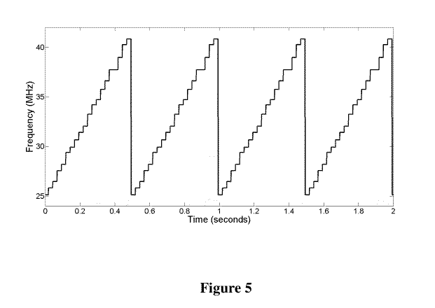

The measurement of multiple modes can also be achieved through sequential measurements of each mode. In this case, one mode is measured, then the system switches to measure the next mode and so on until all the modes are measured; then this cycle repeats itself. For this method to be feasible, the total measurement cycle for all modes should be short enough that no more than one molecule is expected to land on the beam. The board-based measurement platform mentioned in the previous paragraph allows for ultrafast measurement-switch cycles as well. With this method, one can measure, for example, twenty modes at different frequencies using these devices as shown in FIG. 5. Although in this case each resonance frequency comes from the first mode of a different device in a NEMS array, it is clear that the same technique can be applied to the first ten modes of the same structure. The trade-off in this case is that the requisite measurement interval for each molecular adsorption event increases with the number of modes measured. This poses no complication since the flux rate of particles on the device can be adjusted so that many modes can be measured between sequential landing events. The most optimistic molecular flux rate on the NEMS device is one molecule every second, and with the hardware platform one can measure all ten modes within 1 millisecond. The switching rate for the measurement platform is fast enough to avoid suffering from any time resolution issues.

Initial tests in different contexts for tracking multiple NEMS resonances have been demonstrated, and one can extend the technique to successfully achieve the transduction of the first ten modes from the same structure. One can implement both methods and gauge the performance of each method for the subsequent measurements with test samples. An optimal transduction scheme (in terms of ease of implementation) could even be a mixture of both strategies—in which case each hardware platform switches through a subset of the modes (e.g. 5 modes sequentially) and one superpose the output of a few of these systems (e.g. 2 systems simultaneously) on the NEMS device.

An Embodiment: Verification of Mass and Size Measurements with Nanoparticles:

To verify the technique, one can use highly-monodisperse, polymer based nanoparticles. The smallest nanoparticles with sufficient size-uniformity start from 100 nm in diameter; therefore one can target, for example, 100 nm to 400 nm particles for verification purposes. To characterize these nanoparticles which are a little bit larger than previous samples measured with NEMS, one can use a relatively large NEMS (e.g., 10 microns by 800 nm by 100 nm). With nanoparticles in the range of, e.g., 100-400 nm, the error terms are dominated by the fitting error (as can be deduced from Table 1). In practice this means that mass measurements will have 1% error due to the linear combination approximation. Furthermore nanoparticles at this size come with a size dispersion of 2% which translates into a mass dispersion of 6%. Therefore, one expects the mass measurement of any nanoparticle to have an uncertainty of 6%. In terms of positional uncertainty, the fitting error results in an uncertainty of 0.2% which corresponds to 20 nm for the NEMS intended to be used in the experiment. With this position resolution, one should be able to obtain sufficiently good estimates for the nanoparticles one is trying to measure. The nanoparticles will be delivered to the NEMS system through, for example, either electrospray ionization or laser desorption [11].

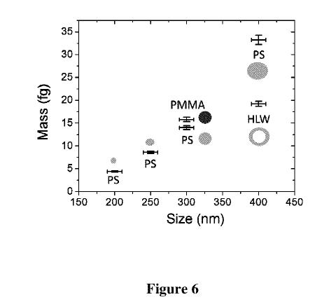

In addition, one can use a systematic change in the diameter of the nanoparticles. One can obtain the samples from a commercial supplier and one can measure the following samples to test the system: 1) Polystyrene nanoparticles of different diameters (e.g., 200-400 nm). Each measurement should yield the expected size and mass values for these nanoparticles. 2) PMMA nanoparticles. PMMA is about 15% denser than polystyrene. For this reason comparison of PMMA and PS nanoparticles of same size can be important; measurement results should yield the same size for each nanoparticle but they should differ in mass. 3) Hollow, Polystyrene nanoparticle. Another useful sample is to use hollow nanoparticles. In comparison with a solid nanoparticle of the same size, hollow nanoparticle should yield a similar extent but a smaller mass. The results expected from these measurements are summarized in FIG. 6.

Biomolecular Measurements: For the verification of technique with biological analytes, one can use a device with smaller dimensions (e.g., 4 microns by 320 nm by 100 nm). Considering the molecular weight of the biosamples, one can expect the measurements to be limited by the fitting error rather than phase noise. This implies that mass measurements will carry a 1% uncertainty level and the position measurements will have 8 nm resolution level. One can by way of example measure the following biological materials:

Tobacco Mosaic Virus is a plant virus with a molecular weight of about 40 MDa. This virus has a rod shape with 17.5 nm diameter and 300 nm length. Previously this virus was measured by conventional mass spectrometry with 10% mass resolution[28]. By using methods described herein, one can improve this measurement to 1% without even optimizing the current linear combination technique. Since the virus will land on the beam randomly, one can obtain a distribution of extents from 17.5 nm to 300 nm with a near-sinusoidal distribution profile.

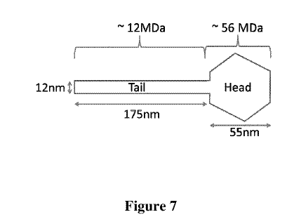

Lambda Phage is an about 68 MDa bacteriophage with a small tail section and a massive head section. The head (capsid) section is an icosahedron with 55 nm length; the tail section is 175 nm long and 12 nm wide (FIG. 7). Due to the asymmetry of the particle, this virus is a good sample for verifying the skewness measurements. Since the virus will land on the beam in random orientations, the average skewness will be zero; however unlike all the other cases, the distribution of skew parameter obtained through single molecule experiments will demonstrate that this particle indeed contains a broad distribution of skewness values. For the maximal case where the virus lies parallel to the beam axis, the skewness is calculated to be about 2. This dimensionless parameter is scaled with respect to standard deviation which is about 50 nm in this case. Therefore the maximal asymmetry corresponds to a length-scale of 50 nm×2=63 nm which the technique can easily measure. The samples presented in this section are by no means an exhaustive list of samples that can verify the present sensing technique. These particular samples were selected based on their availability and the extent to which they can validate the technique. Other materials, such as protein complexes, ribosomes, supercoiled DNA molecules and gold nanoparticles can also be evaluated.

### Part 2: Mathematical Treatment

The mathematical treatments described herein below, for both Parts 2 and 3, can be incorporated into appropriate method steps, software codes, and user interfaces for use in an instrument and for a practical measurement. The mathematical treatments include both the equations and the descriptions of the equations.

One can start by reviewing the fundamental mechanism for nanomechanical mass sensing; eventually one wants to arrive at an equation that explicitly demonstrates the effect of an arbitrary mass distribution on the resonance frequency. The fundamental equation for the resonance frequency of an unperturbed structure can be obtained through the harmonic oscillator model:

$${f}_{0} = \frac{ω}{2 π} = \frac{1}{2 π} \sqrt{\frac{( maximum Potential Energy )}{( maximum Kinetic Energy )}}$$

Here maximum is evaluated within an oscillation cycle. This expression can be calculated by dividing the beam into infinitesimal slices and integrating the potential and kinetic energy contributions of each slice. For a nanomechanical beam that extends along the x axis with a length of l, this integral is:

$${f}_{0} = \frac{1}{2 π} \sqrt{\frac{{\int }_{0}^{L} E {{I}_{y} ( \frac{{\partial }^{2} φ}{\partial {x}^{2}} )}^{2} d x}{{\int }_{0}^{L} {μ}_{0} {φ ( x )}^{2} d x}} \qquad ( 1 )$$

The term E denotes the Young's Modulus, I_{y} denotes the moment of inertia, μᵤ denotes the one-dimensional mass density of the beam and φ(x) denotes the mode-shape (i.e. eigen-function).

When a molecule is adsorbed by the mechanical device, it becomes part of the structure and undergoes mechanical motion in unison with the rest of the structure. The addition of the particle will change both the maximum kinetic and potential energies of the system. For particles of interest—such as biomolecules, biologic structures or polymer nanoparticles—the contribution to the kinetic energy is orders of magnitude larger than the contribution to the potential energy. This is because the densities of these particles are comparable to that of structural material, whereas their Young's moduli are orders of magnitude smaller than that of structural material. Therefore, one can safely neglect any potential energy term in the subsequent analysis. Considering a molecule with random mass distribution, Δμ(x), the maximum kinetic energy of the resonator changes by:

ΔKE=∫₀^{L}Δμ(x)φₙ(x)²dx

This perturbation term can be added to the denominator of equation (1) above. By performing a Taylor expansion on equation (1), one can obtain the frequency shift observed in the n^{th} mode as a function of an arbitrary mass distribution Δμ(x). By slightly rearranging terms, the result can be written as:

−2Mₙδfₙ=∫₀^{L}Δμ(x)φₙ(x)²dx

Here δfₙ is the frequency shift observed in the n^{th} mode of the resonator, normalized with respect to the unperturbed resonance frequency of the n^{th} mode. The term Mₙ is the effective mass for the n^{th} mode of the mechanical beam, which can be readily calculated for any given structure. On the right hand side of the equation, the unknown distribution Δμ(x) is weighed by the square of the mode shape, φₙ(x)², at each point along the beam and this expression is integrated across the entire beam. The remaining left-hand term is the normalized frequency shift, δfₙ, which can be measured. On the right hand side, one knows the mode shapes φₙ(x) for each mode; however one does not know the analyte's mass distribution Δμ(x) and as a result one cannot calculate the integral.

It is easy to observe how the aforementioned approaches for the limiting cases deal with the above equation. First generation experiments with atomic beams assumed a uniform coverage of the beam: Δμ(x)=Δμ and this allowed for a straightforward integration of squared mode-shapes. In the second generation experiments with single molecules, the spatial distribution has been assumed to be an infinitely narrow Dirac Delta distribution: Δμ(x)=m_{particle}×δ(x−x_{particle}). In this case, the integral can be easily calculated with the sampling property of the Dirac Delta function: ∫δ(x−xₚ)φₙ(x)²dx=φₙ(xₚ)².

For a general case, in the absence of the restricting assumptions above, one has to deal with the unknown integrand on the right hand side. In our view, it is impossible to solve for the mass distribution Δμ(x) directly; however it may be possible to extract out relevant parameters only if one can combine these equations in a suitable way. The most critical piece of information one wants to obtain is the total mass of the distribution which can be expressed as: m=∫₀^{L}Δμ(x)dx. In order to see how one can find an estimate for this quantity from the frequency shift data, one can construct a linear combination of the equations, weighing the n^{th} mode by a factor μₙ:

$$\begin{matrix}- {\sum }_{n = 1}^{M} {α}_{n} 2 {M}_{n} δ {f}_{n} = {\sum }_{n = 1}^{M} {α}_{n} {\int }_{0}^{L} Δ μ ( x ) {{φ}_{n} ( x )}^{2} d x \\ = {\int }_{0}^{L} Δ μ ( x ) {\sum }_{n = 1}^{M} {α}_{n} {{φ}_{n} ( x )}^{2} d x\end{matrix}$$

In this linear combination, one wants the right hand side of the equation to approximate the total mass of the beam m=∫₀^{L}Δμ(x)dx. If one adjusts the linear combination of the mode shapes so that it approaches a constant function with unity value, then the combination of frequency shifts approximates the mass:

$$\begin{matrix}- {\sum }_{n = 1}^{M} {α}_{n} 2 {M}_{n} δ f = {\int }_{0}^{L} Δ μ ( x ) {\underbrace{{\sum }_{n = 1}^{M} {α}_{n} {{φ}_{n} ( x )}^{2}}}_{{\approx }_{1}} d x \\ \approx {\int }_{0}^{L} Δ μ ( x ) d x \\ = m\end{matrix}$$

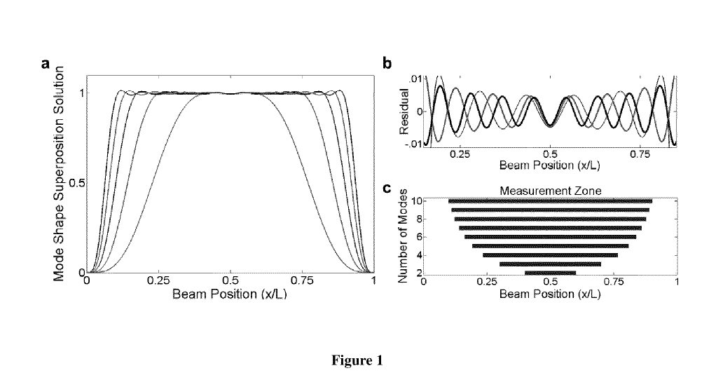

Therefore by adjusting the coefficients αₙ such that Σₙ₋₁^{M}αₙφₙ(x)²−1, one can obtain an approximation for the total mass as: m≈−2Σₙ₌₁^{M}αₙMₙδfₙ. The accuracy of the estimation depends on how well one can estimate the unity function by the superposition of mode-shapes. It has been investigated how well the superposition of mode shapes can approximate the unity function using least-squares error optimization. It was found that by using only four modes, one can already reach a reasonably good approximation. In FIG. 1, it is shown the optimization results up to ten modes.

In assessing the quality of fitting two main factors are considered. The first factor is to minimize the jitter in approximating the unity function (FIG. 1b)—this is dealt through error optimization. The second factor is that the unity function is approximated on a limited range of the device (FIG. 1c). This is necessary because only an infinite number of modes can reconstruct the unity function throughout the entire range (x=0 to x=L). Fortunately, the edges of the nanomechanical beam, which are left out, are also the least sensitive portion of the beam for mass sensing: any particle landing near the edges will produce a sufficiently small signal so as to be considered a ‘missed’ event, outside of the sensor's physical extent. Furthermore, with the use of four or more modes, a good portion of the beam can be covered. The effective area of the beam as a function of mode numbers is shown in FIG. 1. From these graphs it is evident that even four modes are enough for more than, for example, 50% utilization of the sensor surface.

An important feature of the proposed technique is that if an analyte lands partially outside the measurement zone, then this analysis can detect this breach of validity and avoids providing a wrong answer. To arrive at this error diagnosis, one can generate approximations for mass using the combination of different number modes starting with the first two, ending all the way up to the full range of modes. The difference between two successive approximations drops with the number of modes only for a particle residing with the range of validity. If the particle is outside the measurement zone, this monotonic drop in the linear combination sequence is no longer observed, as some of the modes will miss the particles extent and contribute abnormally in the superposition. As a result this technique is robust in the sense that it does not produce false results when particles land outside the measurement zone.

In addition to the particle's total mass, a similar approach can be used to obtain spatial information about the particle itself. When one normalizes the mass distribution Δμ(x) by the particle's total mass m one obtains the probability density function for position, denoted by

$$ρ ( x ) = \frac{Δμ ( x )}{m} .$$

By using the probability density function, spatial parameters of the distribution can be obtained. For instance to calculate the average position:

$$𝔼 [ x ] = {\int }_{0}^{L} ρ ( x ) x d x = \frac{1}{m} {\int }_{0}^{L} Δ μ ( x ) x d x$$

One can reapply the method of linear combinations, this time to construct a superposition of mode shapes that will approximate the function x. In this case each frequency shift δfₙ is weighed by a factor βₙ:

$$\begin{matrix}- \frac{2}{m} {\sum }_{n = 1}^{M} {β}_{n} {M}_{n} δ f = {\int }_{0}^{L} ρ ( x ) {\underbrace{{\sum }_{n = 1}^{M} {β}_{n} {{φ}_{n} ( x )}^{2}}}_{{\approx }_{x}} d x \\ \approx {\int }_{0}^{L} ρ ( x ) x d x \\ = 𝔼 [ x ]\end{matrix}$$

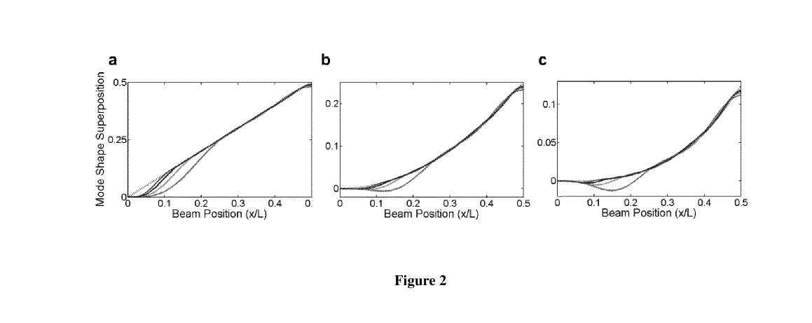

The linear combination of mode shapes Σₘ₋₁^{M}βₙφₙ(x)² can be successfully constructed to approximate the function x, as illustrated in FIG. 2a. In similar fashion, one can calculate the second [x²] and the third [x³] order moments of the position distribution by different linear combinations different mode shapes as shown in FIG. 2b and FIG. 2c. Once these moments are calculated, then one can obtain the extent of the distribution by calculating the variance: σ=\sqrt{(x)²− (x²)}. To characterize the asymmetry of the distribution, one can calculate the skewness: γ= [((x− x̅)/τ)³]. If this parameter is close to zero, it indicates that the mass is distributed evenly around its center. For the doubly-clamped beam the position can be determined only as a distance from the beam center, due to the inherent symmetry of the structure. For applications which require the location of sample molecules directly, cantilever geometry can be used—which is a straightforward extension of the techniques presented here.
Error Considerations: To estimate how well one can estimate the statistical parameters (m, x̅, σ and γ) one needs to quantify the error. One can rewrite the equation for mass:

$$m = - 2 {\sum }_{n = 1}^{M} {α}_{n} {M}_{n} δ {f}_{n} + e ( Δ μ ( x ) )$$

Here the first term on the right hand side corresponds to the approximation, and the second term corresponds to the error introduced by the approximation. Both terms contribute to the uncertainty in the determination of mass: the frequency shift terms (δfₙ) carry frequency noise components within them; whereas the second term quantifies the difference between the ideal and approximating functions. The second error term depends on the specific mass distribution Δμ(x), since the goodness of the fit (FIG. 1b) varies with position. Although one cannot know the particular value of the error term for a given situation, one can calculate the expected value for the variance of the error term by taking an average over all possible mass distributions Δμ(x). For any set of mass distribution, this error term is bounded by:

var(e)≦m²×max(res)²

Here var(.) denotes the variance of the quantity and max(res) denotes the maximum value of the residue between the actual function to be estimated (u(x)−1) and the linear combination (−2ΣαₙMₙδfₙ) within the fitting range. The term m again denotes simply the mass of the particle. By using the variance of fitting error, one can calculate the variance in the determination of mass by simply:

$$var ( m ) \leq {\sum }_{n = 1}^{M} 4 {α}_{n}^{2} {M}_{n}^{2} {σ}_{n}^{2} + {m}^{2} {max ( res )}^{2}$$

Here the term σₙ denotes the Allan variance of the n^{th} mode. Recognizing that the term 2Mₙσₙ is nothing but the minimum detectable mass change for the n^{th} mode, one can rewrite this equation:

$$var ( m ) \leq {\sum }_{n = 1}^{M} {α}_{n}^{2} δ {m}_{n}^{2} + {m}^{2} {max ( res )}^{2}$$

Since the numerical value of the second term on the right hand can be calculated, mass uncertainty in using this technique can be obtained. Error analysis in similar vein can be performed for other parameters (position, extent, skewness) using the residuals for the associated fitting functions. Table 1 shows the error expressions for the first three moments of the distribution. It is emphasized that the fitting error, although sufficient, can be further improved by using different optimization protocols that trade off the detection range with fitting jitter.

These mathematical treatments can be incorporated into instrumental and software packages for use in extracting useful data from physical measurements.

TABLE 1
The detection limit of each parameter is given by the quadratic sum of the
phase noise and fitting error. For each sample, the detection limit is
calculated according to this table.

| | | Phase Noise | Fitting |
|---|---|---|---|
| Parameter | Form for the variance | Error | Error |
| Mass, m | ${\sum }_{n = 1}^{M} {α}_{n}^{2} δ {m}_{n}^{2} + {m}^{2} {max ( res [ α ] )}^{2}$ | ~δm | <10⁻²m |
| Position, x | $\frac{{L}^{2}}{{m}^{2}} {\sum }_{n = 1}^{M} {β}_{n}^{2} δ {m}_{n}^{2} + {L}^{2} {max ( res [ β ] )}^{2}$ | $\sim L \times \frac{δ m}{m}$ | ≦210⁻³L |
| Variance, σ | $\begin{matrix}\frac{{L}^{2}}{{m}^{2}} {\sum }_{n = 1}^{M} ( {β}_{n}^{2} + {γ}_{n}^{2} ) δ {m}_{n}^{2} + \\ {L}^{2} {max ( res [ β ] , res [ γ ] )}^{2}\end{matrix}$ | $\sim 2 L \times \frac{δ m}{m}$ | ≦210⁻³L |

### Cited References for Background and Part 2

1. Schwab, K., E. A. Henriksen, J. M. Worlock, and M. L. Roukes, Measurement of the quantum of thermal conductance. Nature, 2000. 404(6781): p. 974-977.
2. Metzger, C. H. and K. Karrai, Cavity cooling of a microlever. Nature, 2004. 432(7020): p. 1002-1005.
3. Knobel, R. G. and A. N. Cleland, Nanometre-scale displacement sensing using a single electron transistor. Nature, 2003. 424(6946): p. 291-293.
4. LaHaye, M. D., O. Buu, B. Camarota, and K. C. Schwab, Approaching the Quantum Limit of a Nanomechanical Resonator. Science, 2004. 304(5667): p. 74-77.
5. Naik, A., O. Buu, M. D. Lahaye, A. D. Armour, A. A. Clerk, M. P. Blencowe, and K. C. Schwab, Cooling a nanomechanical resonator with quantum back-action. Nature, 2006. 443(7108): p. 193-196.
6. Eichenfield, M., R. Camacho, J. Chan, K. J. Vahala, and O. Painter, A picogram-and nanometrescale photonic-crystal optomechanical cavity. Nature, 2009. 459(7246): p. 550-555.
7. O'Connell, A. D., M. Hofheinz, M. Ansmann, R. C. Bialczak, M. Lenander, E. Lucero, M. Neeley, D. Sank, H. Wang, M. Weides, J. Wenner, J. M. Martinis, and A. N. Cleland, Quantum ground state and single-phonon control of a mechanical resonator. Nature, 2010. 464(7289): p. 697-703.
8. Li, M., H. X. Tang, and M. L. Roukes, Ultra-sensitive NEMS-based cantilevers for sensing, scanned probe and very high-frequency applications. Nat Nano, 2007. 2(2): p. 114-120.
9. Burg, T. P., M. Godin, S. M. Knudsen, W. Shen, G. Carlson, J. S. Foster, K. Babcock, and S. R. Manalis, Weighing of biomolecules, single cells and single nanoparticles in fluid. Nature, 2007. 446(7139): p. 1066-1069.
10. Naik, A. K., M. S. Hanay, W. K. Hiebert, X. L. Feng, and M. L. Roukes, Towards single-molecule nanomechanical mass spectrometry. Nat Nano, 2009. 4(7): p. 445-450.
11. Hanay, M. S., S. Kelber, A. K. Naik, D. Chi, S. Hentz, E. C. Bullard, E. Colinet, L. Duraffourg, and M. L. Roukes, Single-protein nanomechanical mass spectrometry in real time. Nat Nano, 2012. 7(9): p. 602-608.
12. Bargatin, I., I. Kozinsky, and M. L. Roukes, Efficient electrothermal actuation of multiple modes of high-frequency nanoelectromechanical resonators. Applied Physics Letters, 2007. 90(9): p. 093116-3.
13. Cleland, A. N. and M. L. Roukes, Fabrication of high frequency nanometer scale mechanical resonators from bulk Si crystals. Applied Physics Letters, 1996. 69(18): p. 2653-2655.
14. Travis, J., Building bridges to the nanoworld. Science (New York, N.Y.), 1994. 263(5154): p. 1702-1703.
15. Caltech/CEA-LETI Alliance for Nanosystems VLSI, 200 mm (second-generation) Standard NEMS Process: “CAL2” . . . Available from: http://www.nanovlsi.com.
16. Bargatin, I., E. Myers, J. Aldridge, C. Marcoux, P. Brianceau, L. Duraffourg, E. Colinet, S. Hentz, P. Andreucci, and M. Roukes, Large-scale integration of nanoelectromechanical systems for gas sensing applications. Nano Letters, 2012. 12(3): p. 1269-1274.
17. Roukes, M. L. and K. L. Ekinci, Apparatus and method for ultrasensitive nanoelectromechanical mass detection, US Patent Office, U.S. Pat. No. 6,722,200. Provisional 4 May 2001, Awarded 20 Apr. 2004.
18. Ekinci, K. L., X. M. H. Huang, and M. L. Roukes, Ultrasensitive nanoelectromechanical mass detection. Applied Physics Letters, 2004. 84(22): p. 4469-4471.
19. Ilic, B., H. G. Craighead, S. Krylov, W. Senaratne, C. Ober, and P. Neuzil, Attogram detection using nanoelectromechanical oscillators. Journal of Applied Physics, 2004. 95(7): p. 3694-3703.
20. Gupta, A., D. Akin, and R. Bashir, Single virus particle mass detection using microresonators with nanoscale thickness. Applied Physics Letters, 2004. 84(11): p. 1976-1978.
21. Yang, Y. T., C. Callegari, X. L. Feng, K. L. Ekinci, and M. L. Roukes, Zeptogram-Scale Nanomechanical Mass Sensing. Nano Letters, 2006. 6(4): p. 583-586.
22. Jensen, K., K. Kim, and A. Zettl, An atomic-resolution nanomechanical mass sensor. Nature Nanotechnology, 2008. 3(9): p. 533-537.
23. Chiu, H.-Y., P. Hung, H. W. C. Postma, and M. Bockrath, Atomic-Scale Mass Sensing Using Carbon Nanotube Resonators. Nano Letters, 2008. 8(12): p. 4342-4346.
24. Lassagne, B., D. Garcia-Sanchez, A. Aguasca, and A. Bachtold, Ultrasensitive Mass Sensing with a Nanotube Electromechanical Resonator. Nano Letters, 2008. 8(11): p. 3735-3738.
25. Chaste J, Eichler A, Moser J, Ceballos G, Rurali R, and Bachtold A, A nanomechanical mass sensor with yoctogram resolution. Nat Nano, 2012. 7(5): p. 301-304.
26. Henry Huang, X. M., C. A. Zorman, M. Mehregany, and M. L. Roukes, Nanoelectromechanical systems: Nanodevice motion at microwave frequencies. Nature, 2003. 421(6922): p. 496-496.
27. Bargatin, I., E. B. Myers, J. Arlett, B. Gudlewski, and M. L. Roukes, Sensitive detection of nanomechanical motion using piezoresistive signal downmixing. Applied Physics Letters, 2005. 86(13): p. 133109.
28. Trauger, S., T. Junker, and G. Siuzdak, Investigating Viral Proteins and Intact Viruses with Mass Spectrometry, in Modern Mass Spectrometry, C. Schalley, Editor 2003, Springer Berlin Heidelberg. p. 265-282.

### Part 3: Second Priority Provisional

Additional mathematical treatments are provided for shape, mass, and position analysis. Again, the equations and descriptions thereof can be incorporated into appropriate method steps, software codes, and user interfaces for use in an instrument and for a practical measurement. Main textual description is first provided, followed by Supplemental Information.

### Calculating Spatial Moments of a Mass Distribution

In NEMS-MS, each vibrational mode is affected differently by the adsorption of an individual analyte. The mode shapes themselves give rise to a distinct position dependence of these distinct adsorbate-induced frequency shifts [7, 17, 18; see second listing of cited references hereinafter]. For each mode, the induced frequency shift is maximal for adsorption at vibrational antinodes, whereas it vanishes at the nodes. Previously, two resonator modes were employed to measure simultaneously, in real-time, the mass and position-of-adsorption of individual analytes adsorbing upon a NEMS resonator [7]. It has also been demonstrated that the masses and positions of multiple, point-like particles can be calculated using multiple modes of a cantilever [19]. Here, one can show that by employing this new methodology, which incorporates additional adsorbate-induced frequency shifts measured for higher resonator modes, one can deduce all spatial moments of the mass distribution for each adsorbate. (This includes each analyte's total mass and position-of-adsorption.) These can be used to obtain an inertial image of the analyte. Without loss of generality, one can examine the ultimate and practical limits to the sensitivity of this inertial imaging technique for small adsorbate masses, which inherently do not perturb the resonator mode shapes. The analysis proceeds by defining coefficients for the surface loading of a NEMS device by a small analyte (see below Supplementary Information):

Fₙ=∫_{Ω}_{ₛ}μ(r)|Φₙ(r)|²dS (1)

Here μ is the areal mass density distribution of the adsorbed analyte (evaluated normal to the device surface), Φₙ(r) are the natural (vector) vibrational modes of the device in the absence of analyte adsorption—normalized such that ω_{Ω}ρ_{device}(r)|Φₙ(r)|²dV=M, where ρ_{device} is the mass density of the device, M is the device mass, Ω is the device region, and Ωₛ is its surface. Classical linear elasticity [20] allows these coefficients, Fₙ, to be related directly to the discrete, experimentally measured fractional-frequency shifts that are induced upon each analyte adsorption event, Δₙ=(ωₙ−ωₙ⁽⁰⁾/ωₙ⁽⁰⁾. Here, ωₙ⁽⁰⁾ is the unperturbed angular frequency of the n^{th} mode, and ωₙ is the shifted angular frequency after adsorption of the analyte. As detailed in the Supplementary Information, the analysis yields

F=−2ΔₙM. (2)

Equation (1) indicates the relevance of these coefficients: the F, are weighted spatial averages of the analyte's mass distribution function. It follows then, that moments of the analyte's mass distribution, m^{(k)}, can be determined directly by forming linear combinations of these functions,

m^{(k)}=Σₙ₋₁^{N}αₙ^{(k)}Fₙ=∫_{Ω}_{ₛ}μ(r)g^{(k)}(r)dS (3)

Here,

$${g}^{( k )} ( r ) = {\sum }_{n = 1}^{N} {α}_{n}^{( k )} {\vert {Φ}_{n} ( r ) \vert}^{2}$$

are linear superpositions with N (total number of measured n=1 modes) terms, involving the squared magnitudes of the unperturbed mode shapes, which are evaluated at the device surface. These are, in turn, superposed using coefficients αₙ^{(k)} chosen in the specific manner described immediately below; the superscript within parentheses, (k), represents the moment order. Using Eqs. (2) and (3), one can relate the moments, m^{(k)}, directly to the experimentally measured set of analyte-induced fractional-frequency shifts, {Δₙ}, through

m^{(k)}=−2MΣₙ₋₁^{N}αₙ^{(k)}Δₙ. (4)

For example, the adsorbate mass m can be deduced from experiments by first picking a particular set of coefficients αₙ⁽⁰⁾ to create a superposition that ideally gives g⁽⁰⁾(r)=1 over the integration region Ωₛ; in this case ∫_{Ω}_{ₛ}μ(r)dS=m=m⁽⁰⁾=∫_{Ω}_{ₛ}μ(r)g⁽⁰⁾(r)dS. Similarly, creating a superposition g⁽¹⁾(r)=x, by picking a different set of coefficients, allows the analyte's position-of-adsorption—its center of mass along the x-direction—to be deduced. This can be generalized to higher-order moments.

### Case Study: a Doubly-Clamped Beam

As an example, consider a one-dimensional elastic beam; the position vector r is thus replaced by the beam coordinate, x, and one solves for the linear mass density, λ(x). One can calculate m⁽⁰⁾, m⁽¹⁾, and in turn, <x>=m⁽¹⁾/m⁽⁰⁾, which is the analyte's center-of-mass along the beam coordinate; this is proportional to ∫₀^{L}×λ(x)dx, where L is the beam length. Creating a higher order expansion along x, one forms g⁽²⁾(x)=x² to obtain m⁽²⁾. This, in turn, allows deduction of the analyte's standard deviation in x—that is, its average size along the x coordinate, σₓ=\sqrt{m⁽²⁾−(m⁽¹⁾)²}/m⁽⁰⁾. Analogous relations yield even higher spatial moments of the analyte's mass distribution along x—for example the analyte's skewness and kurtosis, which involve g³(x)=x³ and g⁽⁴⁾(x)=x⁴, respectively (Supplementary Information). With a sufficiently complete set of the spatial moments of the analyte's mass distribution, {m^{(k)}}—deduced for each adsorbing analyte in real time from the experimentally obtained multimodal frequency-shift data of the NEMS resonator's response—an image of the analyte can be determined [21, 22]. This will be discussed below.

Equation (2) applies generally, to mechanical devices of any geometry and composition (Supplementary Information). The spatial dimensionality of m^{(k)} arises directly from the spatial variation of the vibrational modes employed in their expansions in Eq. (3). For example, the out-of-plane displacements of a doubly-clamped beam change with one spatial variable along the longitudinal axis, x. Such modes provide moments of the adsorbate mass distribution along that one coordinate. Vibrational mode shapes that vary along two coordinates, such as for thin plates, can provide two-dimensional moments of the adsorbate distribution.

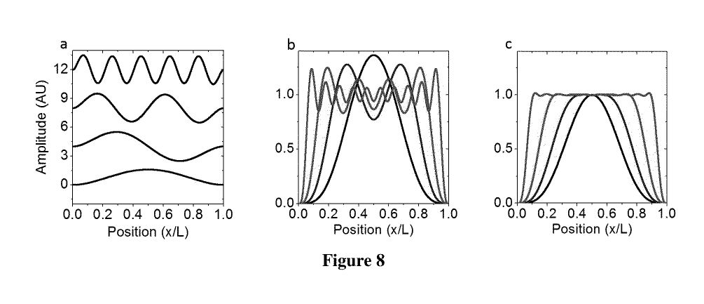

FIG. 8 presents mode shapes and superpositions for the out-of-plane displacements of an ideal doubly-clamped beam of length L. For such a one-dimensional device the entire (linear) spatial domain Ωₗ is xε[0, 1], since variations over the transverse direction are integrated implicitly. FIG. 8a depicts the first, second, fourth, and tenth mode shapes along the longitudinal coordinate, x. In FIG. 8b one demonstrates use of superpositions to approximately yield g⁽⁰⁾(x)=1 over the full length of the beam; these involve from one up to ten modes. One determines the optimal coefficients, αₙ⁽⁰⁾ for the expansion of g⁽⁰⁾(x) through least-squares analysis. It can be shown rigorously that a unique analytic solution for these coefficients exists (Supplementary Information).

The fidelity of the adsorbate's inertial image is determined by how well, over the entire integration region, Ωₛ, the finite superpositions g^{(k)}(r) used in Eq. (3) converge to their targeted spatial functions. For the specific case illustrated in FIG. 8, involving one-dimensional modes of a doubly-clamped beam, one seeks an expansion g⁽⁰⁾(x)=1 that converges over Ωₗ. FIG. 8b shows an effect resembling the familiar Gibbs phenomenon (over- and under-shoot); this indicates that choosing Ωₗ to span the full beam length L is not ideal. Such a choice would, in turn, yield moments that poorly approximate those of the analyte mass distribution. FIG. 8c shows that convergence to g⁽⁰⁾(x)=1 over Ωₗ improves very significantly with choice of a slightly foreshortened integration region. Practically, foreshortening Ωₗ implies a reduced measurement zone—in other words, such improvement comes at the cost of excluding a small fraction of experimental data (for analytes that adsorb outside Ωₗ.) Such a small reduction in the measurement zone, Ωₗ, is inconsequential.

As long as Ωₗ spans the extents of the analyte, the error, ε^{(k)} for the moment k varies with a power of the measurement zone, ε^{(k)}∝Ωₗ^{N+1/2}/N! where N is the number of modes, as long as N>k+1. For an accurate estimation of the k^{th} moment, at least k+1 modes are needed, and the accuracy obtained increases rapidly as more modes are employed (Supplementary Information).

### Adaptive Fitting to Minimize Error

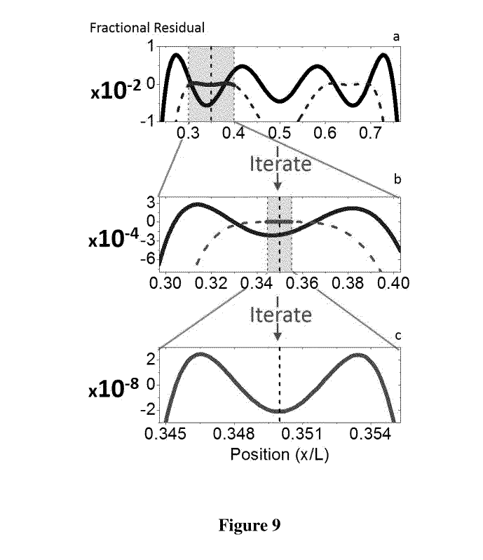

To be useful in mass spectrometry and inertial imaging of biomolecules, the NEMS mass sensor must be of sufficient size that individual analytes are small compared to the device dimensions. In this case, adaptive fitting of the measurement zone Ωₛ to the analyte size can markedly decrease the residual error in inertial imaging. This straightforward computational procedure can be carried out in real-time without loss of generality. After each set of adsorption-induced frequency shifts are acquired; no additional measurements are required. FIG. 9 demonstrates this concept for a doubly-clamped beam: the expansion interval Ωₗ is progressively shrunk, iteratively, around the position of the adsorbate, after the analyte's location is determined from the first pass of analysis. An exponential decrease in uncertainty is attainable (Supplementary Information); FIG. 9 demonstrates a decrease in residual error by six orders of magnitude as Ωₗ is ultimately reduced to a region somewhat larger than the size of the analyte. One can find adaptive fitting converges—that is, the residual error saturates at a minimum level—typically after less than ten iterations (Supplementary Information). In fact, this procedure enables convergent measurements over a larger fraction of the beam; hence, the region excluded can be reduced.

To evaluate the k^{th} moment of the analyte mass distribution, a minimum of k+1 modes must be measured (Supplementary Information). For example, deducing the average analyte mass (zeroth moment) and position (first moment) requires two modes (Supplementary Information), consistent with previous methods [7]. As mentioned, increasing the {Φₙ(r)}basis set in the expansions for g^{(k)}(r) beyond the minimum requisite k+1 modes provides increased accuracy. The ultimate attainable resolution is determined by the frequency stability of the resonator modes, as described below.

Mass and Position Validation with Experimental Data

The methodology was validated by analyzing data from two experimental studies.

The first study measured single IgM antibodies by using multimode theory and the first two driven, in-plane flexural displacement modes of a doubly-clamped beam NEMS resonator [7]. In the second study, shifts in the resonance frequency of the first four out-of-plane flexural modes of a microscale cantilever device were measured as a gold bead was manually positioned, stepwise, along the device length [17].

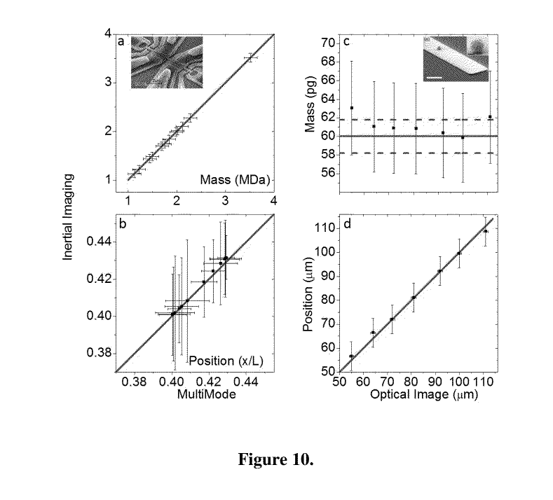

The results of our new analysis of the first study are shown in FIGS. 10a and 10b. The two-mode frequency shift data is used to calculate the mass (FIG. 3a) and position (FIG. 10b) of the particles using inertial imaging, and these results are compared to the previously validated multimode theory [7]; the latter implicitly assumes that the analyte is a point particle. Error bars along both axes (2-sigma, 95% confidence level) illustrate the effects of both experimental noise and, in the case of inertial imaging, residual errors. The deduced mass and position show excellent agreement between inertial imaging and multimode theory.

FIGS. 10c and 10d compare the results in the second study between inertial imaging and direct measurements of the gold bead on the cantilever from optical microscopy. The 4-mode frequency measurements reported in [17] are used to calculate the bead's mass and position from inertial imaging. This comparison shows excellent agreement for both mass and position.

Evaluation of particle size from these experimental data is more difficult. The first data set includes only two modes and is, thus, insufficient to permit such analysis (Supplementary Information). The second data set, when analyzed for particle size, yields uncertainty comparable to the measured value because of the significant noise present in the data. Nonetheless, the uncertainty in deduced size is in agreement with the expected contact size (Supplementary Information).

### Simulations Demonstrate Particle Image Reconstruction

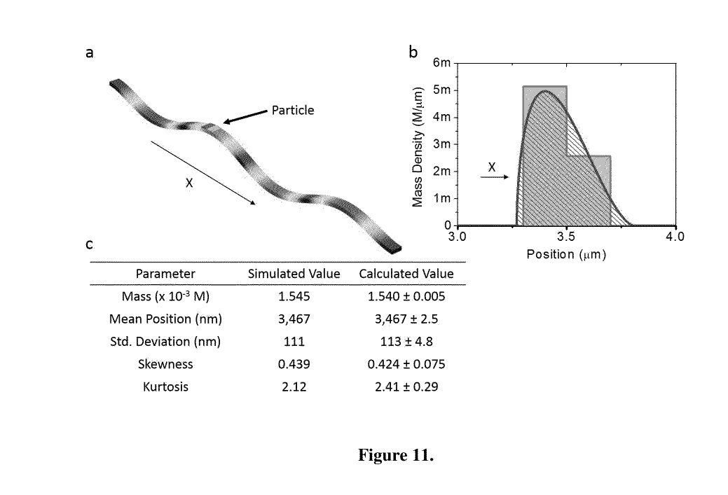

To provide a robust validation of inertial imaging of molecular shape one presents FEM simulations of the response of a device to a test particle. The analyte is modeled as a small rectangular addendum to a doubly clamped beam—with specific mass, position, density, stiffness, and shape shown in FIG. 11a. For illustrative purposes the particle is defined to be much smaller than the wavelength of the highest mechanical mode employed in the expansions for the moments, {m^{(k)}}. The test particle's mass distribution is asymmetric and has a step-like density profile (FIG. 11b); this gives it high spatial Fourier components. Particle-induced frequency shifts for the first five out-of-plane displacement modes are calculated and these are, in turn, used to calculate the first five moments by inertial imaging theory. From these moments one deduces particle mass, position, size, skewness and kurtosis. As seen in FIG. 11e, moments deduced from inertial imaging theory are quite accurate. It is possible to reconstruct the test particle's inertial image from these deduced moments by employing a variety of different techniques [22-26]. To provide a concrete demonstration, one employs the Pearson distribution method [27]. In FIG. 11b, the reconstructed image is compared with the original, simulated density profile. As shown, the reconstructed image is in good agreement with the abrupt original mass distribution; this shows good fidelity considering that only five moments of the distribution were used. FEM simulations for different particle positions were conducted to further validate the inertial imaging method (Supplementary Information). Discretization error present in FEM is the primary source of uncertainty in these simulations (convergence information is provided in the Supplementary Information).

### Discussion

In experiments, both the analyte's mass distribution function and its mechanical coupling to the surface of the NEMS sensor play important roles in determining the magnitude of the induced fractional-frequency shifts, {Δₙ}. Hence, the nature of the physical attachment of the analyte to the resonator is also probed. Soft biological analytes, such as proteins, are ideal targets for inertial imaging; there is a standard NEMS-MS protocol of cooling the sensor induces strong physisorption [7]. Accordingly, van der Waals and chemical forces will cause the analyte to comply with the sensor's surface topography. However results inferred from frequency shifts induced by rigid analytes, such as for metallic nanoparticles, will instead reflect an inertially-imaged size that is representative of the region of attachment; this may be smaller than the particle diameter.

Beyond such experimental details, the primary source of uncertainty—and the ultimate limit to the resolution of inertial imaging—arises from the frequency instability of the resonator. This fundamental uncertainty in determining the moments of the analyte distribution function can be evaluated using standard methods of error propagation with Eq. (4) and knowledge about the spectral density of the resonator's frequency fluctuations (Supplementary Information). In Table 2 is provided examples of the anticipated frequency-noise-limited size resolution that is attainable with current micro- and nano-resonator technology; as shown, today's smallest devices are capable of atomic-scale resolution. Inertial imaging enables measurements of both the mass and molecular shape of analytes that adsorb on a nanomechanical resonator. Analogous to the previous nanomechanical measurements of mass and position-of-adsorption of individual proteins [7], inertial imaging is possible in real time, as individual analytes adsorb on a NEMS sensor one-by-one. This represents a paradigm shift in the realm of resonator-based particle sensing—to now permit spatially resolved imaging of analytes. The ultimate resolution of this technique is not limited by the modal wavelengths, but instead only by the inherent frequency instability of the nanomechanical resonators employed. NEMS-based inertial imaging can enable single-molecule mass spectrometry and, simultaneously, evaluation of molecular shapes with atomic-scale resolution.

TABLE 2

| | | | | Min. |
|---|---|---|---|---|
| | | | Est. | Spatial |
| | Dimensions | | Allan | Resolution |
| Device | (L × w × t) | | Deviation | (nm) |
| Silicon | 200 × 33 × 7 | (μm) | 1 × 10⁻⁸ | 370 |
| Microbeam [11] | | | | |
| Silicon | 10 × 0.3 × 0.1 | (μm) | 8 × 10⁻⁸ | 15 |
| Nanobeam [7] | | | | |
| Graphene | 1760 × 200 × 0.14 | (nm) | 1.3 × 10⁻⁶ | 4.2 |
| Nanoribbon [6] | | | | |
| SW Carbon | 150 × 1.7 × 1.7 | (nm) | 2 × 10⁻⁶ | 0.3 |
| Nanotube [15] | | | | |

Table 2. Imaging resolution capabilities of current micro- and nanomechanical resonators. The diameters of the smallest measureable analytes are tabulated for the cases of a hollow silicon microbeam [11], silicon nanobeam [7], graphene nanoribbon [6], and a single-wall carbon nanotube [15]. Doubly clamped beam geometry with actual device dimensions, and deduced experimental values for resonator frequency instability are employed. Frequency fluctuations are characterized by the Allan deviation, which was either reported directly or deduced from the reported mass sensitivity. The attainable spatial resolution is calculated assuming a rigidly adsorbed hemispherical particle with 2 g/cm³ mass density, from measurements of the first four mechanical modes (assumed to have identical frequency stabilities).

### Cited References for Part 3

1. Ekinci, K. L., X. M. H. Huang, and M. L. Roukes, Ultrasensitive nanoelectromechanical mass detection. Applied Physics Letters, 2004. 84(22): p. 4469-4471.
2. Ilic, B., et al., Attogram detection using nanoelectromechanical oscillators. Journal of Applied Physics, 2004. 95(7): p. 3694-3703.
3. Yang, Y. T., et al., Zeptogram-Scale Nanomechanical Mass Sensing. Nano Letters, 2006. 6(4): p. 583-586.
4. Li, M., H. X. Tang, and M. L. Roukes, Ultra-sensitive NEMS-based cantilevers for sensing, scanned probe and very high-frequency applications. Nature Nanotechnology, 2007. 2(2): p. 114-120.
5. Gil-Santos, E., et al., Nanomechanical mass sensing and stiffness spectrometry based on two-dimensional vibrations of resonant nanowires. Nature Nanotechnology, 2010. 5(9): p. 641-5.
6. Chen, C. Y., et al., Performance of monolayer graphene nanomechanical resonators with electrical readout. Nature Nanotechnology, 2009. 4(12): p. 861-867.
7. Hanay, M. S., et al., Single-protein nanomechanical mass spectrometry in real time. Nat Nano, 2012. 7(9): p. 602-608.
8. Naik, A. K., et al., Towards single-molecule nanomechanical mass spectrometry. Nat Nano, 2009. 4(7): p. 445-450.
9. Schmid, S., et al., Real-time single airborne nanoparticle detection with nanomechanical resonant filter-fiber. Sci Rep, 2013. 3: p. 1288.
10. Gupta, A., D. Akin, and R. Bashir, Single virus particle mass detection using microresonators with nanoscale thickness. Applied Physics Letters, 2004. 84(11): p. 1976-1978.
11. Burg, T. P., et al., Weighing of biomolecules, single cells and single nanoparticles in fluid. Nature, 2007. 446(7139): p. 1066-1069.
12. Jensen, K., K. Kim, and A. Zettl, An atomic-resolution nanomechanical mass sensor. Nature Nanotechnology, 2008. 3(9): p. 533-7.
13. Chiu, H. Y., et al., Atomic-scale mass sensing using carbon nanotube resonators. Nano Lett, 2008. 8(12): p. 4342-6.
14. Lassagne, B., et al., Ultrasensitive mass sensing with a nanotube electromechanical resonator. Nano Lett, 2008. 8(11): p. 3735-8.
15. Chaste, J., et al., A nanomechanical mass sensor with yoctogram resolution. Nature Nanotechnology, 2012. 7(5): p. 300-303.
16. Ekinci, K. L., Y. T. Yang, and M. L. Roukes, Ultimate limits to inertial mass sensing based upon nanoelectromechanical systems. Journal of Applied Physics, 2004. 95(5): p. 2682-2689.
17. Dohn, S., et al., Enhanced functionality of cantilever based mass sensors using higher modes. Applied Physics Letters, 2005. 86(23).
18. Dohn, S., et al., Mass and position determination of attached particles on cantilever based mass sensors. Review of Scientific Instruments, 2007. 78(10).
19. Dohn, S., et al., Position and mass determination of multiple particles using cantilever based mass sensors. Applied Physics Letters, 2010. 97(4).
20. Landau, L. D., et al., Theory of elasticity. 3rd English ed. Course of theoretical physics. 1986, Oxford Oxfordshire; New York: Pergamon Press. viii, 187 p.
21. Hausdorff, F., Moment problems for a infinite interval. Mathematische Zeitschrift, 1923. 16: p. 220-248.
22. Athanassoulis, G. A. and P. N. Gavriliadis, The truncated Hausdorff moment problem solved by using kernel density functions. Probabilistic Engineering Mechanics, 2002. 17(3): p. 273-291.
23. Mead, L. R. and N. Papanicolaou, Maximum-Entropy in the Problem of Moments. Journal of Mathematical Physics, 1984. 25(8): p. 2404-2417.
24. Ngoc, T. M. P., A statistical minimax approach to the Hausdorff moment problem. Inverse Problems, 2008. 24(4).
25. Wu, X. M., Calculation of maximum entropy densities with application to income distribution. Journal of Econometrics, 2003. 115(2): p. 347-354.
26. AuYeung, S. W., Finding probability distributions from moments. Master's Thesis, imperial College, London, 2003.
27. Pearson, K., Contributions to the mathematical theory of evolution. II. Skew variation in homogeneous material. Philosophical Transactions of the Royal Society of London. A, 1895. 186: p. 343-414.

### Part 3: Supplemental Information

1. Derivation of Eq. (2) in main text

Precipitous downward shifts in the modal resonance frequencies of a nanomechanical device occur upon adsorption of individual analytes [1]. These measured frequency shifts can be used to calculate the mass, position, and molecular shape of individual analytes that adsorb upon a NEMS resonator as described in the main text. Importantly, in the limit where the particle mass is much less than the device mass, the sequential measurement of multiple particles is unaffected by the mass loading due to previous particles.

Previous analyses [1, 2] have considered the analyte particles to be point masses. In this work, one models the individual particles as finite-sized objects with a spatial mass distribution that is initially unknown. One considers a general device of arbitrary composition that is loaded by an adsorbate with mass, m, which is much less than the device mass, M. One further assume that the particle size is small compared to the device dimensions (and the wavelengths of the vibrational modes) or, if not, that the particle is much more compliant than the device itself. Under such conditions, which are especially relevant for the case of soft biological molecules (a preferred embodiment), the vibrational mode shapes of the device are unaffected by the adsorbed analyte, and thus the strain energy of the device is also unchanged. It then follows that, to a good approximation, the maximum kinetic energy of the device, before and after mass loading, is invariant for the same oscillation amplitude, i.e.,

$$\begin{matrix}K {E}_{unloaded} = K {E}_{loaded} , \\ where & ( S5 ) \\ K {E}_{unloaded} = \frac{1}{2} {( {ω}_{n}^{( 0 )} )}^{2} {\int }_{Ω} {ρ}_{device} ( r ) {\vert {Φ}_{n} ( r ) \vert}^{2} d V , & ( S6 ) \\ K {E}_{loaded} = \frac{1}{2} {( {ω}_{n} )}^{2} {\int }_{Ω + {Ω}_{analyze}} \{ {ρ}_{device} ( r ) + ρ ( r ) \} {\vert {Φ}_{n} ( r ) \vert}^{2} d V , & ( S7 )\end{matrix}$$

where ρ_{device}(r) is the mass density of the device and ρ(r) is the mass density of the analyte absorbed onto the device surface, ωₙ⁽⁰⁾ and ωₙ are the angular resonance frequencies of the unloaded and loaded devices, Φₙ(r) are the natural (vector) vibrational modes of the device in the absence of analyte adsorption, Ω is the spatial integration domain of the device, and Ω_{analyte} is the spatial integration domain of the analyte.

One considers that an adsorbate that is compliant with the device surface, i.e., as the device vibrates, the analyte moves with identical velocity to the device surface at any normal position to the surface. This is expected to hold for analytes of sufficiently small mass that the device mode shapes remain unaffected. The volume integral in Eq. (S7) over the analyte's volume can then be replaced by a surface integral involving its areal mass density μ (evaluated by integrating ρ(r) normal to the surface),

∫_{Ω}_{_{analyte}}ρ|Φₙ|²dr=∫_{≠}_{ₛ}μ|Φₙ|²dS, (S8)

where Ωₛ is the surface of the device.

Equations (S5)-(S8) then give

$${Δ}_{n} ≡ \frac{{ω}_{n} - {ω}_{n}^{( 0 )}}{{ω}_{n}^{( 0 )}} = - \frac{1}{2} \frac{{\int }_{{Ω}_{s}} μ {\vert {Φ}_{n} \vert}^{2} d S}{{\int }_{Ω} {ρ}_{device} {\vert {Φ}_{n} \vert}^{2} d V} . \qquad ( S9 )$$

One requires that the modes satisfy the normalization condition

∫_{Ω}ρ_{device}(r)|Φₙ(r)|²dV=M, (S10)

which, for a device of constant density, coincides with the usual orthonormal condition, i.e., ∫_{Ω}|Φₙ(r)|²dV=1. Equations (S8)-(S10) then yield the required result,

Fₙ=−2ΔₙM, (S11)

where Fₙ=∫_{Ω}_{ₛ}ρ(r)|Φₙ(r)|²dV

2. Evaluating Higher Moments of the Analyte's Mass Distribution

In the main text, it was examined the zeroth moment of the analyte density distribution for a doubly-clamped beam—this gives the analyte mass, m. Since a beam is a one-dimensional device, one derives results for the analyte's linear mass density, λ(x), i.e., the mass density integrated over the normal and lateral (i.e., transverse) directions of the beam surface. Here, one extends this analysis to obtain the first three higher-order moments: (i) the center-of-mass of the analyte (position), (ii) the analyte's average size (standard deviation), and (iii) its skewness (asymmetry).

### First Moment (Position):

To evaluate the position of the analyte, coefficients αₙ⁽¹⁾ in Eq. (3) (main text) must be chosen such that

$${g}^{( 1 )} ( x ) = {\sum }_{n = 1}^{N} {α}_{n}^{( 1 )} {Φ}_{n}^{2} ( x ) = x \qquad ( S12 )$$

over the spatial domain, Ωₗ, which for a (one-dimensional) beam is xε[0,1]; x is normalized by the beam length, L. Due to the inherent symmetry in Φₙ²(x), about x=½, Eq. (S12) can be applied over either subdomain x≦½, or x≧½, but not both. Satisfaction of Eq. (S12) over the subdomain 0≦x≦½, will thus yield a distribution of g⁽¹⁾(x)=1−x for ½≦x≦1. Since the analyte's size is much smaller than the beam length, and the beam is symmetric about x=½, the choice of subdomain is inconsequential and simply defines the origin.

The particle position is therefore given by:

$$〈 x 〉 ≡ \frac{{\int }_{0}^{1} x λ ( x ) d x}{{\int }_{0}^{1} λ ( x ) d x} = \frac{{\int }_{0}^{1} {g}^{( 1 )} ( x ) λ ( x ) d x}{{\int }_{0}^{1} {g}^{( 0 )} ( x ) λ ( x ) d x} = \frac{{m}^{( 1 )}}{{m}^{( 0 )}} = \frac{{\sum }_{n = 1}^{N} {α}_{n}^{( 1 )} {Δ}_{n}}{{\sum }_{n = 1}^{N} {α}_{n}^{( 0 )} {Δ}_{n}} , \qquad ( S13 )$$

This provides the particle position relative to the nearest clamped end of the beam. Note that the particle position is defined by a rational function that involves the fractional-frequency shifts, Δₙ, of N modes. Once these shifts have been experimentally measured, all that is required are the coefficients for the zeroth and first moments, αₙ⁽⁰⁾ and αₙ⁽¹⁾ (see main text).

Since the mode shapes of a doubly-clamped beam have a boundary layer near both clamped ends, whose length scale is O(1/n) relative to the beam length, it is chosen to evaluate the coefficients αₙ⁽¹⁾ over a region that excludes these boundary layers. One selects this region to be

$$\frac{N}{1 + {N}^{2}} \leq x \leq 1 / 2 , \qquad ( S14 )$$

where N=1, 2, 3, . . . represents the highest mode used in the measurement. For the zeroth moment calculated in the main text, which requires g⁽⁰⁾(x)=1, this region is extended to be symmetric about x=½.

Evaluating the coefficients αₙ⁽¹⁾ using a least-squares fit over the region in Eq. (S14), and using the coefficients αₙ⁽⁰⁾ determined previously for the zeroth moment (see main text), yields the results in Figure S1(A). Note that the function

$${g}^{( 1 )} ( x ) = {\sum }_{n = 1}^{N} {α}_{n}^{( 1 )} {Φ}_{n}^{2} ( x ) \qquad ( S15 )$$

provides an excellent approximation to g⁽¹⁾(x)=x within the specified measurement zone, Eq. (S14).

### Second Moment (Size):

The size of the analyte is specified by the standard deviation of its density distribution, which requires evaluation of the second moment,

$${g}^{( 2 )} ( x ) = {\sum }_{n = 1}^{N} {α}_{n}^{( 2 )} {Φ}_{n}^{( 2 )} ( x ) = {x}^{2} , \qquad ( S16 )$$

over the spatial domain Ωₗ. Again the coefficients αₙ⁽²⁾ are obtained using a least-squares analysis over the domain in Eq. (S14) only, due to the small size of the analyte relative to the beam length.

The required variance (square of standard deviation) of the analyte's density is then given by

$${σ}_{x}^{2} = \frac{{m}^{( 2 )}}{{m}^{( 0 )}} - {( \frac{{m}^{( 1 )}}{{m}^{( 0 )}} )}^{2} = \frac{{\sum }_{n = 1}^{N} {α}_{n}^{( 2 )} {Δ}_{n}}{{\sum }_{n = 1}^{N} {α}_{n}^{( 0 )} {Δ}_{n}} - {( \frac{{\sum }_{n = 1}^{N} {α}_{n}^{( 1 )} {Δ}_{n}}{{\sum }_{n = 1}^{N} {α}_{n}^{( 0 )} {Δ}_{n}} )}^{2} . \qquad ( S17 )$$

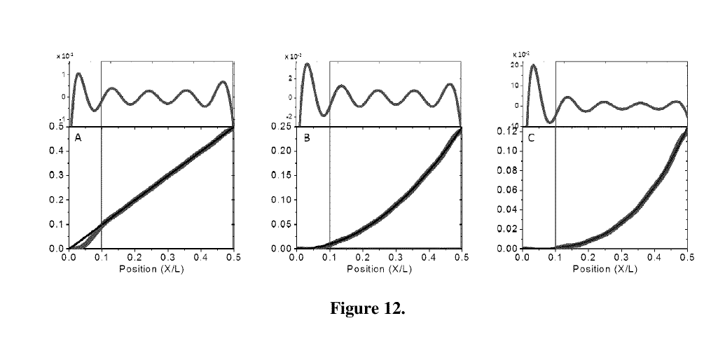

Evaluation of Eq. (S17) requires the coefficients for the zeroth moment, αₙ⁽⁰⁾, first moment, αₙ⁽¹⁾ and the second moment, αₙ⁽²⁾. Evaluating the coefficients αₙ⁽²⁾ over the interval in Eq. (S14), as before, yields the results in FIG. 12(B). Again note the excellent agreement with the required result in Eq. (S16).

Since a narrow doubly-clamped beam can be represented as a one-dimensional resonator, the standard deviation and all higher order quantities are specified solely along the beam axis, i.e. in the x-direction. In this simplest case, one excludes higher families of modes, e.g. torsional, etc.

### Third Moment (Asymmetry):

To evaluate the third moment, one requires the coefficients αₙ⁽³⁾ such that

$${g}^{( 3 )} ( x ) = {\sum }_{n = 1}^{N} {α}_{n}^{( 3 )} {Φ}_{n}^{2} ( x ) = {x}^{3} , \qquad ( S 18 )$$

The skewness, ηₓ, is then specified by

$${η}_{x} = {( \frac{{( {m}^{( 0 )} )}^{2}}{{m}^{( 0 )} {m}^{( 2 )} - {( {m}^{( 1 )} )}^{2}} )}^{\frac{3}{2}} ( \frac{{m}^{( 3 )}}{{m}^{( 0 )}} - 3 \frac{{m}^{( 1 )} {m}^{( 2 )}}{{( {m}^{( 0 )} )}^{2}} + 2 {( \frac{{m}^{( 1 )}}{{m}^{( 0 )}} )}^{3} ) , \qquad ( S 19 )$$

where, as previously defined,

$${m}^{( 3 )} = - 2 M {\sum }_{n = 1}^{N} {α}_{n}^{( 3 )} {Δ}_{n} . \qquad ( S20 )$$

Note that the formulas above for analyte position, variance and skewness are independent of the device mass, M; again, they are specified only along the longitudinal beam axis, x.

The coefficients αₙ⁽³⁾ required to calculate skewness are again evaluated over the interval in Eq. (S14), and corresponding results for g⁽³⁾(x)=x³ are given in FIG. 12(C).

3. Uniqueness of Solution

The function g^{(k)}(r) specifies the order of the moments, m^{(k)}, in Eq. (3) (main text), and is expressed as a linear superposition over the squared magnitude of the mode shapes:

$${g}^{( k )} ( r ) = {\sum }_{n = 1}^{N} {α}_{n}^{( k )} {\vert {Φ}_{n} ( r ) \vert}^{2} . \qquad ( S21 )$$

Here, the unknown coefficients, {αₙ^{(k)}}, are determined using a least-squares analysis. One derives an explicit solution for them, which provides a condition for the uniqueness of solution.

The goal of the least-squares analysis is to determine the fit parameters, {αᵢ^{(k)}}, such that the residual

$${Θ}^{2} ( \{ {α}_{i}^{( k )} \} ) ≡ {\int }_{Ω} {( {\sum }_{n = 1}^{N} {α}_{n}^{( k )} {\vert {Φ}_{n} ( r ) \vert}^{2} - {g}_{exact}^{( k )} ( r ) )}^{2} d V , \qquad ( S22 )$$

is minimized, where g_{exact}^{(k)}(r) is the exact function to be approximated by Eq. (S21). The coefficients are specified by the stationary condition:

$$\frac{\partial {Θ}^{2}}{\partial {α}_{i}^{( k )}} = 0. \qquad ( S23 )$$

From Eqs. (S22) and (S23) one obtains

Tₘₙαₙ^{(k)}=bₘ, (S24)

where

Tₘₙ=∫_{Ω}|Φₘ(r)|²|Φₙ(r)|²dV, (S25)

bₘ=∫_{Ω}g_{exact}^{(k)}(r)|Φₘ(r)|²dV. (S26)

Thus, provided that the inverse, Tₘₙ⁻¹, exists, the unique solution to the fit parameters, {αᵢ^{(k)}}, is

αₙ^{(k)}=Tₘₙ⁻¹bₘ. (S27)

The condition of uniqueness of solution thus reduces to establishing that the matrix Tₘₙ is non-singular.

While a general proof establishing the singular or non-singular nature of Tₘₙ is difficult to obtain for an arbitrary device, it can be determined straightforwardly for a specific device once the modes Φₘ(r) have been evaluated. For the doubly-clamped beam one considers in the main text, the matrix Tₘₙ is non-singular; therefore, the least-squares analysis provides a unique solution to the fit parameter {αᵢ^{(k)}}.

4. Uncertainty in Least Squares Analysis

Here it is shown that the RMS error (square root of the residual), Θ, in Eq. (S22), decreases polynomially as the measurement zone is reduced, and exhibits a super-exponential decrease as the number of modes, N, is increased. As in the main text, one consider a (one-dimensional) doubly-clamped beam. The particle is centered at the position, x₀, and the spatial extent of the measurement zone is 2x′, i.e., the measurement zone is x₀−x′≦x≦x₀+x′.

For this device and measurement zone, Eq. (S22) becomes

$$\begin{matrix}{Θ}^{2} ( \{ {α}_{i}^{( k )} \} ) ≡ {\int }_{{x}_{0} - {x}^{′}}^{{x}_{0} + {x}^{′}} {[ {g}^{( k )} ( x ) - {g}_{exact}^{( k )} ( x ) ]}^{2} d x , \\ where & ( S28 ) \\ {g}^{( k )} ( x ) = {\sum }_{n = 1}^{N} {α}_{n}^{( k )} {Φ}_{n}^{2} ( x ) . & ( S29 )\end{matrix}$$

Throughout one assumes x′<<1, and examine the effect of reducing the measurement zone size. Accordingly, one approximates both g^{(k)}(x) and g_{exact}^{(k)}(x) by their Taylor expansions around x₀,

$$\begin{matrix}{g}_{exact}^{( k )} ( x ) = {\sum }_{m = 0}^{∞} \frac{{( x - {x}_{0} )}^{m}}{m !} \frac{{\partial }^{m} {g}_{exact}^{( k )}}{\partial {x}^{m}} {\vert}_{x = {x}_{0}} , & ( S30 ) \\ {g}^{( k )} ( x ) = {\sum }_{n = 1}^{N} {α}_{n}^{( k )} {\sum }_{m - 0}^{∞} \frac{{( x - {x}_{0} )}^{m}}{m !} \frac{{\partial }^{m} {Φ}_{n}^{2}}{\partial {x}^{m}} {\vert}_{x = {x}_{0}} . & ( S31 )\end{matrix}$$

Substituting the Taylor expansions, Eqs. (S30) and (S31) into Eq. (28) gives

$${Θ}^{2} = 2 {\sum }_{m = 0}^{∞} \frac{{( {x}^{′} )}^{2 m + 1}}{( 2 m + 1 ) {( m ! )}^{2}} {( \frac{{\partial }^{m} {g}_{exact}^{( k )}}{\partial {x}^{m}} {\vert}_{x = {x}_{0}} - {\sum }_{n = 1}^{N} {α}_{n}^{( k )} \frac{{\partial }^{m} {Φ}_{n}^{2}}{\partial {x}^{m}} {\vert}_{x = {x}_{0}} )}^{2} . \qquad ( S32 )$$

Since Eq. (S32) is an asymptotic (power series) expansion in x′, the coefficients αₙ^{(k)} that minimize the residual are specified by the zeros of each term in the sum over m, i.e.

$$\frac{{\partial }^{m} {g}_{exact}^{( k )}}{\partial {x}^{m}} {\vert}_{x = {x}_{0}} - {\sum }_{n = 1}^{N} {α}_{n}^{( k )} \frac{{\partial }^{m} {Φ}_{n}^{2}}{\partial {x}^{m}} {\vert}_{x = {x}_{0}} = 0. \qquad ( S33 )$$

Importantly, a finite number of coefficients αₙ^{(k)} exist in Eq. (S33); for n=1, 2, . . . , N. Thus, to ensure a unique solution, Eq. (S33) must contain N independent equations, m=0, 1, 2, . . . , N−1. Substituting Eq. (S33) into Eq. (S32) thus yields the dominant term:

$${Θ}^{2} = \frac{2 {( {x}^{′} )}^{2 N + 1}}{( 2 N + 1 ) {( N ! )}^{2}} {( \frac{{\partial }^{N} {g}_{exact}^{( k )}}{\partial {x}^{N}} {\vert}_{x = {x}_{0}} - {\sum }_{n = 1}^{N} {α}_{n}^{( k )} \frac{{\partial }^{N} {Φ}_{n}^{2}}{\partial {x}^{N}} {\vert}_{x = {x}_{0}} )}^{2} + O ( [ {( {x}^{′} )}^{2 N + 3} ] ) . \qquad ( S34 )$$

As such, one finds that for large N the leading order behavior of the square root of the residual is

$$\begin{matrix}Θ \sim \frac{\sqrt{2} {( {x}^{′} )}^{N + 1 / 2}}{N ! \sqrt{2 N + 1}} {f}^{( N )} ( {x}_{0} ) , \\ where & ( S35 ) \\ {f}^{( N )} ( {x}_{0} ) = \frac{{\partial }^{N} {g}_{exact}^{( k )}}{\partial {x}^{N}} {\vert}_{x = {x}_{0}} - {\sum }_{n = 1}^{N} {α}_{n}^{( k )} \frac{{\partial }^{N} {Φ}_{n}^{2}}{\partial {x}^{N}} {\vert}_{x = {x}_{0}} . & ( S36 )\end{matrix}$$

Equation (S35) is the required result; it shows that the RMS error (square root of residual) exhibits super-exponential convergence in the number of modes, N, and polynomial convergence with respect to the measurement zone size, 2x′. The function ƒ^{(N)}, converges with increasing N as the superposition of mode shapes (and the Nth derivatives thereof) better approximate g_{exact}^{(k)}.

5. Initial Measurement Zone for a Doubly-Clamped Beam

The mass responsivity of a doubly-clamped beam vanishes at its clamping ends. Accordingly, adsorption events very close to these regions must be excluded as they will provide frequency jumps with poor signal-to-noise ratios. FIG. 8(C) of the main text illustrates that g⁽⁰⁾(x) converges to unity over an increasingly wider region, as additional modes are included. This region is termed the “measurement zone”. One defines the spatial extent of this region by an accuracy criterion, prescribed below.

The spatial extent over which calculated values for the adsorbed mass, m, converge depends upon the number of modes employed; this coincides with the measurement zone. For N modes, the measurement zone is defined to be Ωₗ^{(N)} and spans the region xε[½−Δx_{N}, ½+Δx_{N}]; regions of length Δx_{N} at the clamped ends are excluded. The aim is to determine Δx_{N} such that measured accuracy of the adsorbate, in the measurement zone, is specified.

Accuracy Criterion: The length Δx_{N} is calculated using the following criterion: The function g⁽⁰⁾(x) is identical to unity in the measurement zone, Ωₗ^{(N)}, to within a specified tolerance δ, i.e.,

g⁽⁰⁾(x)−1≦δ (S37)

for all positions x within Ωₗ^{(N)}. This guarantees that the measured mass is determined to within the same accuracy, in the measurement zone. One chooses the nominal value, δ=0.01, corresponding to 1% tolerance.

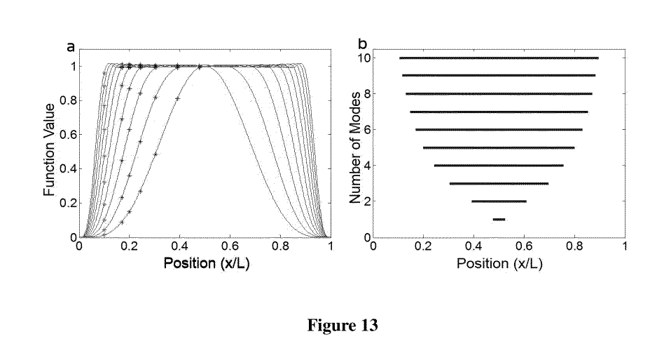

For N=1, the measurement zone is in the immediate vicinity of x=½. However, a small deviation from this position, for example at x=0.4, leads to a significant deterioration in accuracy. Increasing the distance from the beam center enhances the error monotonically; see FIG. 13(A).

The situation improves for N=2, where the measurement zone size increases markedly. The measured mass of the particle at position, x=0.4, is now in good agreement with the true value, as illustrated in FIG. 13(A). Nonetheless, as the adsorption position moves closer to the clamped ends, the mass error again increases.

For N≧2, the size of the measurement zone increases monotonically with N and adsorption positions closer to the clamped ends can yield good mass accuracy. One thus observes that increasing the number of modes extends the spatial extent of the measurement zone.

This measurement zone specification (Eq. (S14) is well approximated by:

$$\frac{N}{1 + {N}^{2}} \leq x \leq 1 - \frac{N}{1 + {N}^{2}} ; \qquad ( S38 )$$

This criterion was used in all of the calculations reported in the main text.

Since the mode shapes vanish at the clamped ends, adsorption in the immediate vicinity of the clamps cannot provide good mass accuracy, regardless of the number of modes used. This is reflected in Eq. (S38), which excludes the clamped ends for any finite number of modes, N.

FIG. 13(B) illustrates the measurement zones (as specified by the above accuracy criterion) for N=1 to 10. For analytes adsorbed within these zones (pictured), mass determination with good accuracy is possible. As the number of modes is increased, the measurement zone expands, allowing larger useful capture cross-sections for the device.

From the considerations above, one now formulates an operational method for quickly determining whether a randomly placed adsorbate falls within the measurement zone Qₗ^{(N)}. Importantly, mass error decreases monotonically with increasing N for adsorption outside the measurement zone, but is invariant (to within δ=1%) within the measurement zone for n={1,2}, {1,2,3}, . . . {1,N}; see FIG. 13(A). Thus, by measuring the adsorbate mass using an increasing number of modes, from 1 up to N modes, the presence of the adsorbate within the measurement zone for N modes can be readily established. The precise location of the adsorbate need not be determined for this purpose.

The chosen tolerance level of δ=1% approximately matches the empirical measurement zone, Eq. (S38). Reducing this tolerance level leads to a smaller measurement zone size, whereas increasing δ sacrifices measurement accuracy for spatial extent. As will be shown in the next section, adaptive fitting can dramatically improve the accuracy level below this initial tolerance level, δ.

6. Demonstration of Adaptive Fitting for a Doubly-Clamped Beam

As discussed in Section S4, a reduction in measurement zone size decreases the residual in the least-squares analysis. Importantly, this residual is directly related to measurement accuracy. One can therefore systematically reduce the measurement zone size using adaptive fitting, as described below, to systematically improve the accuracy of all moments. This in turn enhances the accuracy of adsorbate attributes determined from them, namely: mass, mean (center-of-mass position), standard deviation (particle size), and skewness (first asymmetry moment).

Adaptive fitting: The measurement zone in this (iterative) adaptive fitting procedure is chosen to be

x −2σₓ≦x≦ x +2σ

where x is the measured mean position of the adsorbate, and σₓ is its measured standard deviation, both evaluated using the previously chosen measurement zone.

Initially, the measurement zone size is set to its maximum value, using Eq. (S38). The position and standard deviation of the adsorbate are then determined. These values are substituted into Eq. (S39), which defines a new (reduced) measurement zone, from which new estimates of the moments are determined. This procedure is repeated until convergence is achieved. Since a reduction in measurement zone size improves the accuracy of measurements (see Section 4), this procedure enables maximum accuracy to be achieved.

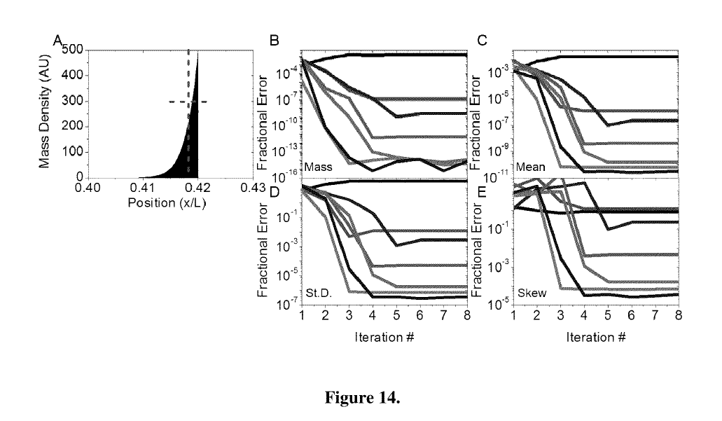

Results of this procedure are given in FIGS. 14(B)-(E), where it is observed that the fractional errors plateau after about 3-5 iterations of adaptive fitting. Note that a dramatic reduction in measurement error is achieved using only a few iterations, with fractional errors decreasing by many orders of magnitude. As expected, the error decreases as the number of modes used increases; this feature is also discussed in Section 4.

7. Minimum Number of Modes Required for a Doubly-Clamped Beam

One calculates the number of modes, N, required to determine the mass, position, standard deviation and skewness of an adsorbate, in the limit where the adsorbate and measurement zone size vanish. Recall that the adsorbate must lie within the measurement zone. Therefore, this calculation gives the minimum number of modes required to measure the properties of infinitesimally small adsorbates.

The measurement zone is centered at x=x₀, and spans the domain x₀−x′≦x≦x₀+x′. Shrinking the measurement zone to zero thus formally corresponds to taking the asymptotic limit, x′→0. To obtain an exact measurement in this asymptotic limit, g^{(k)}(x) must exactly represent g_{exact}^{(k)}(x). One formally expands g^{(k)}(x) in its Taylor series about x=x₀:

$${g}^{( k )} ( x ) = {\sum }_{n = 1}^{M} \frac{\partial {g}^{( k )}}{\partial x} {\vert}_{x = {x}_{0}} \frac{{( x - {x}_{0} )}^{n}}{n !} + O ( {[ x - {x}_{0} ]}^{M + 1} ) . \qquad ( S40 )$$

### 7.1 Mass (Zeroth Moment)

One first considers the measurement of analyte mass, for which g_{exact}⁽⁰⁾(x)=1. If one uses only one mode, N=1, then equating the leading order term in Eq. (S40) to g_{exact}⁽⁰⁾(x) gives

1=α₁⁽⁰⁾Φ₁²(x₀)+O(x−x₀), (S41)

which has the solution, α₁⁽⁰⁾=1/Φ₁²(x₀). Thus, one mode is sufficient to represent the function g_{exact}⁽⁰⁾(x)=1 in the measurement zone. In the limit x′→0 this is asymptotically exact since all higher order terms in the Taylor expansion (Eq. (S40)) vanish. Therefore, as the size of the adsorbate vanishes, i.e. as the particle becomes point-like, only one mode (N=1) is required to measure its mass.

Using more than one mode, N>1, enables higher order terms in the Taylor expansion, Eq. (S40), to be set to zero. However, their inclusion is inconsequential to the accuracy of the measured mass, since these terms vanish in the limit, x′→0; hence, use of more than one mode simply rearranges the distribution of the coefficients αₙ^{(k)}, with no effect on the measured mass.

### 7.2 Center-of-Mass Position (First Moment)

In this case, the required function is g_{exact}⁽¹⁾(x)=x. As before, one first assumes use of only one mode, i.e., N=1, and equate the leading-order term in Eq. (S40) to g_{exact}⁽¹⁾(x)—this gives x=α₁⁽¹⁾Φ₁²(x₀)+O(x−x₀), which has no solution. Thus, frequency jumps from a single mode alone cannot provide analyte position measurements.

However, using two modes (N=2) gives:

$$x = {α}_{1}^{( 1 )} {Φ}_{1}^{2} ( {x}_{0} ) + {α}_{2}^{( 1 )} {Φ}_{2}^{2} ( {x}_{0} ) + ( x - {x}_{0} ) \{ {α}_{1}^{( 1 )} {Φ}_{1} ( {x}_{0} ) \frac{\partial {Φ}_{1} ( {x}_{0} )}{\partial x} + {α}_{2}^{( 1 )} {Φ}_{2} ( {x}_{0} ) \frac{\partial {Φ}_{2} ( {x}_{0} )}{\partial x} \} + {O ( x - {x}_{0} )}^{2} . \qquad ( S42 )$$

This has a unique solution that can be obtained upon equating powers of x. This yields two simultaneous equations for the unknown coefficients, α₁⁽¹⁾, α₂⁽²⁾. Consequently, use of two modes is sufficient to represent the function g_{exact}⁽¹⁾(x)=x, in the limit x′→0. Two modes (N=2), therefore, allows for exact determination of particle position, as the adsorbate size vanishes.

As in the case of mass measurements (zeroth moment), use of more modes (N>2) enables higher order terms in the Taylor expansion to be set to zero. Since these terms vanish as x′→0, it is found that use of only 2 modes enables the exact position to be determined. Use of more than two modes does not affect position determination in this limit.

7.3 Standard deviation, skewness, and higher moments

A similar analysis can be applied to evaluation of the higher moments of the mass density distribution, e.g., g⁽²⁾(x)≈x², g⁽³⁾(x)≈x³, etc. These moments enable measurement of the standard deviation, skewness, and higher asymmetries of the adsorbate's density distribution, i.e., its size and shape. It can be easily shown, in a manner analogous to that performed for the mass and position (above), that the number of modes required to exactly measure the n^{th} moment is N=n+1, in the limit of an adsorbate of infinitesimal size. As above, use of additional modes has no effect on the accuracy of the measured moments, in this limit.

8. Size Calculations from Experiments Using a Microcantilever and a Manually-Positioned Gold Particle

Data was analyzed from the experiments of [3] which provide frequency shifts for four modes (N=4), induced by mass loading of an individually-positioned gold particle along a microcantilever beam [3]. This data permits successful validation of the particle's mass and position using inertial imaging theory (main text).

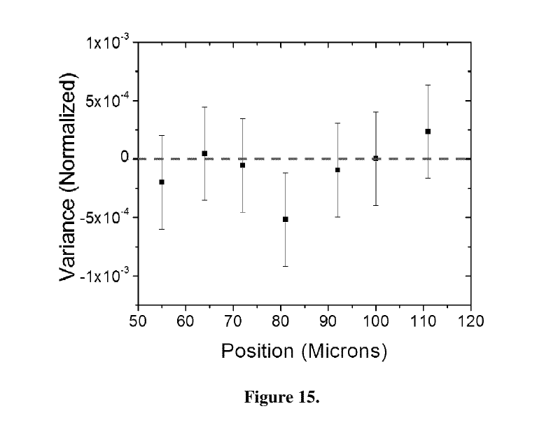

The relative frequency fluctuations in these mode measurements are estimated to be roughly 1×10⁻⁴. In FIG. 15 one plots the particle's measured variance (square of the standard deviation of its density distribution) evaluated from this experimental data using inertial imaging theory. The variance is normalized by the squared beam length, and presented for particle placement at different positions along the beam (measured by optical microscopy in [3]) Importantly, frequency fluctuations (noise) in these measurements are sufficiently large to yield (unphysical) negative values for the measured variance: one obtains a normalized variance of (−0.85±1)×10⁻⁴—this represents the averaged variance ±2×the standard error; see Figure S4.

The actual particle radius, measured by scanning electron microscopy, is 0.9 μm [3]. Since the particle is attached to the beam only over a small region of the particle surface, the standard deviation probed by inertial imaging theory will be a small fraction of the full particle diameter. Comparing the upper bound for the particle size (normalized to the beam length of 200 μm) from inertial imaging theory (\sqrt{1.5×10⁻⁵}□3.8×10⁻³, FIG. 15) to the actual particle size relative to the beam (0.9 μm/200 μm=4.5×10⁻³) shows that the uncertainty (due to frequency noise) is not sufficient to resolve the small size of the particle contact area. Nonetheless, the results from inertial imaging are consistent with the estimated contact size, which is less than the true particle size, since the true contact size lies well within the error bars.

9. Inertial Imaging Validation Using Finite Element Simulations

Finite element (FE) results in the main text were performed using Mindlin thick plate theory (COMSOL) to facilitate accurate simulation of higher order moments, such as kurtosis; this was limited only by available computational resources. The mesh used in these simulations was systematically refined until a convergence 2×10⁻⁵ (fractional difference in eigen-frequencies for a twofold increase in mesh size) was achieved. The final mesh used in the simulation contains 1.6 million elements. In the simulations, three different placement positions were used. In each position, the particle was simulated both for positive and negative skew configurations. The results of these simulations yield similar performance in estimating the physical parameters of the particle and these values are used to calculate the error statistics reported in FIG. 11(C). The observed error in FIG. 11(C) is approximately correlated with increasing statistical order, i.e., mass, position, SD, skewness, kurtosis, and is due to an accumulation of FE discretization error, as expected. To within the estimated uncertainty, these simulations agreed with full 3D simulations of the device. However, 3D simulations were computationally expensive and did not allow for evaluation of the kurtosis with sufficient convergence, hence motivating the use of Mindlin plate theory.

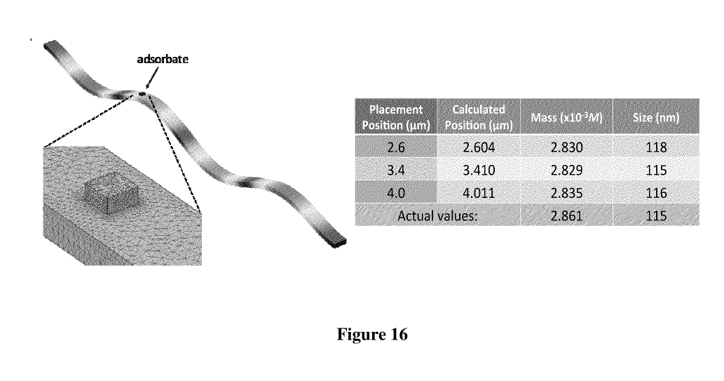

In both the Mindlin theory and full 3D simulations, the analyte is modeled as a small rectangular addendum to a doubly-clamped beam—with specific mass, position, density, and shape. The simulated particle for full 3D simulations is shown in FIG. 16. For illustrative purposes, this test particle is chosen to be much smaller than the wavelength of the highest mechanical mode employed in evaluating the moments, i.e., N=4. This test particle is placed at various positions along the beam, and frequency shifts for the first four out-of-plane flexural modes are obtained by comparing the simulations in which the particle is placed on the beam against those with no particle on the beam. Inertial imaging theory is then used to calculate the particle mass, position, and size from the frequency shifts. The numerical accuracy of the simulations for the determination of the fractional frequencies is found to be ˜5×10⁻⁵. This finite numerical accuracy plays a somewhat similar role to frequency noise in real experiments; in this way uncertainty estimates for different moments can be obtained. As seen in FIG. 16 (for full 3D simulations), values measured using inertial imaging theory are all well within expected uncertainties of the different modes as determined by the numerical accuracy levels. Similar results were obtained for Mindlin plate theory (not shown).

10. Convergence of FEM Simulations

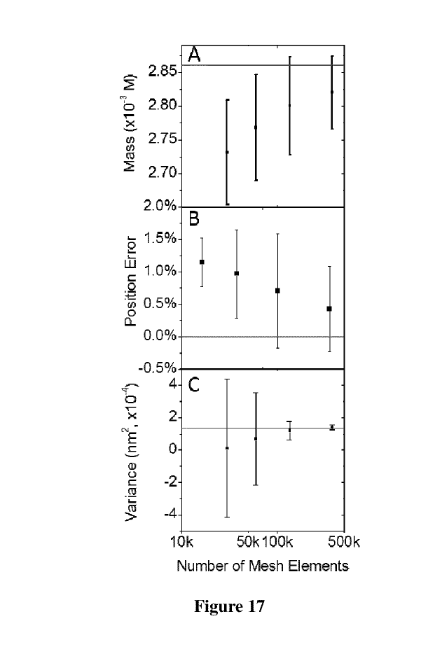

For Mindlin plate theory, the same mesh was used for loaded and unloaded beams; this was systematically refined until convergence was achieved. For the 3D simulations, however, since different meshes are obviously required for loaded and unloaded cases, an alternate procedure was used. The 3D mesh was systematically refined for the loaded and unloaded cases independently, the resonance frequencies extracted in each case, and convergence of the fractional frequency shift monitored until the required convergence was achieved. Frequency shifts for the first four modes were obtained by FEM analysis. These were substituted into inertial imaging theory to obtain results for mass, position, and variance of the test particle. As seen in FIG. 17, mesh refinement not only results in convergence towards the expected values, but also reduces the scatter in values obtained at different positions along the beam. Note that the deduced mass values converge to a slightly different value than the exact result. This reflects a small (˜1%) and expected systematic error between Euler-Bernoulli beam theory and the full 3D FEM. These results thus validate the robustness of the inertial imaging theory, and the accuracy of the FEM results presented. Again, similar results were obtained for Mindlin plate theory (not shown).

11. Effect of Frequency Noise on Adsorbate Size Measurement Using a Doubly-Clamped Beam

To measure the adsorbate's size, the zeroth, first, and second moments must be considered, and the corresponding coefficients αₙ⁽⁰⁾, αₙ⁽¹⁾, αₙ⁽²⁾ evaluated. The standard deviation of the adsorbate's spatial density distribution can then be measured using

$$\begin{matrix}{σ}_{x}^{2} \approx \frac{{m}^{( 2 )}}{{m}^{( 0 )}} - {( \frac{{m}^{( 1 )}}{{m}^{( 0 )}} )}^{2} , \\ where & ( S43 ) \\ {m}^{( k )} = - 2 M {\sum }_{n = 1}^{N} {α}_{n}^{( k )} {Δ}_{n} , & ( S44 )\end{matrix}$$

and the coefficients αₙ^{(k)} are solved using:

$${g}^{( k )} ( x ) = {\sum }_{n = 1}^{N} {α}_{n}^{( k )} {Φ}_{n}^{2} ( x ) = {x}^{k} \qquad ( S45 )$$

over a specified measurement zone.

Since the uncertainty in size dominates the uncertainty in mass and position—size is derived using calculated mass and position values (see Eq. (S43))—one can directly calculate the statistical uncertainty, Γ, due to frequency noise. For cases where the error in the lower order moments is significant, the uncertainty in higher order moments will reflect this error in lower order moments. This dependence can be calculated through standard error propagation procedures. One characterizes the relative strength of frequency fluctuations in each mode, n, by their Allan deviations σ_{A,n}. In general, these are different for each mode, n.

$$Γ ( {\{ {σ}_{A , n} \}}_{N} ) \approx \sqrt{\frac{4 {\sum }_{n = 1}^{N} {( {α}_{n}^{( 2 )} {σ}_{A , n} )}^{2}}{{( \frac{m}{M} )}^{2}}} . \qquad ( S46 )$$

The adsorbate and total beam masses are m and M, respectively. Γ is then the statistical uncertainty in the standard deviation of the adsorbate's distribution. Heavier adsorbates, relative the beam, are thus easier to image as they register a larger frequency response compared to the frequency noise. As the adsorbate's size is reduced, frequency fluctuations will dominate the residual error illustrated in FIGS. 8 and 9 of the main text. Thus, the adsorbate-size resolution of a given system is fully determined by Eq. (S46). This equation indicates that use of additional modes is helpful only if those modes do not involve too much additional frequency noise.

### REFERENCES FOR SUPPLEMENTAL INFORMATION

1. Hanay, M. S., et al., Single-protein nanomechanical mass spectrometry in real time. Nature Nanotechnology, 2012. 7(9): p. 602-608.
2. Naik, A. K., et al., Towards single-molecule nanomechanical mass spectrometry. Nature Nanotechnology, 2009. 4(7): p. 445-450.
3. Dohn, S., et al., Enhanced functionality of cantilever based mass sensors using higher modes. Applied Physics Letters, 2005. 86(23).

What is claimed is:

1. A method comprising:
disposing a NEMS mass spectrometer resonator and disposing a sample flux so that the resonator can adsorb sample from the sample flux while the resonator is being driven in multiple resonance modes,
collecting resonance frequency data, and
estimating the mass and the shape of the sample from the resonance frequency data.

2. The method of claim 1, wherein the shape is estimated with use of a skewness parameter.

3. The method of claim 1, wherein in measuring the shape of the sample the sample is not assumed to have a zero spatial extent.

4. The method of claim 1, wherein the method is used for real-time, single-particle mass and shape analysis simultaneously.

5. The method of claim 1, wherein the method is used for determining if the sample has a symmetric or asymmetric spatial distribution.

6. The method of claim 1, wherein the method is used to measure at least two samples and the shape and/or density of the two samples are compared.

7. The method of claim 1, wherein the sample flux comprises neutral atoms or molecules.

8. The method of claim 1, wherein the sample flux comprises particles.

9. The method of claim 1, wherein the sample flux comprises particles having average diameter of at least 100 nm.

10. The method of claim 1, wherein the sample flux comprises nanoparticles.

11. The method of claim 1, wherein the sample flux comprises polymer nanoparticles.

12. The method of claim 1, wherein the sample flux comprises biological structures.

13. The method of claim 1, wherein the sample flux comprises at least one protein or at least one virus.

14. The method of claim 1, wherein the resonator is driven with transduction of at least three modes of the resonator.

15. The method of claim 1, wherein the resonator is driven with transduction of three to twelve modes of the resonator.

16. The method of claim 1, wherein the resonator is a cantilever, a doubly-clamped beam, or a membrane.

17. The method of claim 1, wherein the resonator is driven simultaneously in its modes.

18. The method of claim 1, wherein the resonator is driven sequentially in its modes.

19. The method of claim 1, wherein the resonator is driven simultaneously and sequentially in its modes.

20. The method of claim 1, wherein estimation step includes estimation for mass, position, or shape, or combinations thereof, carried out by inertial imaging.

21. The method of claim 1, wherein the estimation step is carried out with use of adaptive fitting.

22. The method of claim 1, wherein the estimation step is carried out with finite element modeling.

23. The method of claim 1, wherein the sample includes soft analytes.

24. The method of claim 1, wherein the sample includes rigid analytes.

25. The method of claim 1, wherein the resonator comprises a compliant surface layer.

26. An instrument adapted for carrying out the method of claim 1.

27. Computer-readable media for carryout out the estimation step of claim 1.

28. A method comprising:
disposing a NEMS mass spectrometer resonator in the path of a sample flux so that the resonator can adsorb sample from the sample flux while the resonator is being driven in multiple resonance modes,
collecting resonance frequency data, and
estimating the mass and the shape of the sample from the resonance frequency data.

29. A method comprising:
disposing a NEMS mass spectrometer resonator and disposing a sample flux so that the resonator can adsorb sample from the sample flux while the resonator is being driven in multiple resonance modes,
collecting resonance frequency data, and
deducing all spatial moments of the mass distribution for each adsorbate including total mass and position.

30. The method of claim 1, wherein the mass is estimated as a total mass, m, according to:
$$m \approx - 2 {\sum }_{n = 1}^{M} {α}_{n} {M}_{n} δ {f}_{n}$$
wherein:
αₙ is a factor used to weigh the nth mode;
Mₙ is the effective mass for the nth mode of the resonator.
δfₙ is the frequency shift observed in the nth mode of the resonator.

31. The method of claim 1, wherein the shape is estimated with use of a probability density function for position denoted by:
$$ρ ( x ) = \frac{Δ μ ( x )}{m}$$
wherein:
m is total mass, and
Δμ(x) is the mass distribution of the adsorbate.

32. The method of claim 1, wherein the shape of the adsorbate is estimated with use of the equations and mathematical treatment:
$$- \frac{2}{m} {\sum }_{n = 1}^{M} {β}_{n} {M}_{n} δ {f}_{n} = {\int }_{0}^{L} ρ ( x ) \underbrace{{\sum }_{n = 1}^{N} {β}_{n} {{φ}_{n} ( x )}^{2}}_{ρ ( x )} d x \approx {\int }_{0}^{L} ρ ( x ) x \cdot d x = E [ x ]$$
wherein, the first moment (E[x]) of the particle is solved for; and
wherein
Mₙ is the effective mode mass of the device
m is the mass of particle as calculated above
βₙ is a factor (similar to but different than αₙ) that is used to weight the nth mode; and
wherein higher order moments of the particle (e.g. E[x²], E[x³], E[x⁴] . . . ) are calculated in the same way, using different weight factors (the sets of {βₙ}).

33. The method of claim 1, wherein the shape of the adsorbate is estimated with use of the equations and mathematical treatment:
the k^{th} moment of the adsorbate's mass density distribution is given as:
m^{(k)}=−2MΣₙ₌₁^{N}αₙ^{(k)}Δₙ
Where:
m^{(k)} is the k^{th} moment
aₙ^{(k)} are calculated coefficients for the k^{th} moment and the n^{th} mode of the device
M is the total device mass
Δₙ is the measured frequency shift for the n^{th} mode (N total modes are measured)
The coefficients, αₙ^{(k)}, are calculated using:
$${g}^{( k )} ( r ) = {\sum }_{n = 1}^{N} {α}_{n}^{( k )} {\vert {Φ}_{n} ( r ) \vert}^{2}$$
where Φₙ(r) are the mode shapes of the device over the generalized spatial coordinate, ‘r’.
